(19) United States
(12) Patent Application Publication
(10) Pub. No.: US 2011/0088052 A1
(43) Pub. Date: Apr. 14, 2011

(54) METHODS AND APPARATUS TO DETERMINE AUDIENCE VIEWING OF VIDEO-ON-DEMAND PROGRAMS

(76) Inventors: Arun Ramaswamy, Tampa, FL (US); David Howell Wright, Safety Harbor, FL (US); William A. Feininger, Palm Harbor, FL (US)

(21) Appl. No.: 12/970,710

(22) Filed: Dec. 16, 2010

Related U.S. Application Data
(63) Continuation of application No. 10/589,149, filed on Aug. 11, 2006.
(60) Provisional application No. 60/563,874, filed on Apr. 19, 2004.
(60) Provisional application No. 60/545,595, filed on Feb. 18, 2004.

(51) Int. Cl. H04H 60/32; H04N 7/173

(52) U.S. Cl. 725/16; 725/93

(57) ABSTRACT

Methods and apparatus to determine audience viewing of video-on-demand programs are disclosed. An example method disclosed herein to monitor presentation of video-on-demand content comprises obtaining server metering data determined using a server metering device in communication with a video-on-demand server, the video-on-demand server to provide the video-on-demand content specifically to a first subscriber site among a plurality of subscriber sites, obtaining subscriber metering data corresponding to media content presented at the first subscriber site, the subscriber metering data determined using a site metering device different from the server metering device, and combining the subscriber metering data and the server metering data to monitor the video-on-demand content provided specifically to the first subscriber site.

### RELATED APPLICATIONS

This patent arises from a continuation of U.S. patent application Ser. No. 10/589,149, entitled “Methods and Apparatus to Determine Audience Viewing of Video-on-Demand Programs” and filed on Aug. 11, 2006, which is a national stage entry of International Application Serial Number PCT/US05/05271, entitled “Methods and Apparatus to Determine Audience Viewing of Video-on-Demand Programs” and filed on Feb. 18, 2005. This patent also claims priority from U.S. Provisional Application Ser. No. 60/545,595, entitled “Methods and Apparatus to Determine Audience Viewing of Video-on-Demand Programs” and filed on Feb. 18, 2004, and U.S. Provisional Application Ser. No. 60/563,874, entitled “Server-Based Methods and Apparatus to Determine Audience Viewing of Video-On-Demand Programs” and filed on Apr. 19, 2004. U.S. patent application Ser. No. 10/589,149, International Application Serial Number PCT/US05/05271, U.S. Provisional Application Ser. No. 60/545,595 and U.S. Provisional Application Ser. No. 60/563,874 are hereby incorporated by reference in their entirety.

### FIELD OF THE DISCLOSURE

This disclosure relates generally to audience measurement and, more particularly, to methods and apparatus to determine audience viewing of video-on-demand programs.

### BACKGROUND

Television ratings and metering information is typically generated by collecting viewing records and/or other viewing information from a group of statistically selected households. Each of the statistically selected households typically has a data logging and processing unit commonly referred to as a “home unit.” In households having multiple viewing sites (e.g., multiple television systems), the data logging and processing functionality may be distributed among a single home unit and multiple “site units,” one site unit for each viewing site. The home unit (or the combination of the home unit and the site unit) is often in communication with a variety of attachments that provide inputs to the home unit or receive outputs from the home unit. For example, a source identification unit such as a frequency detector attachment may be in communication with a television to sense a local oscillator frequency of the television tuner. In this manner, the frequency detector attachment may be used to determine the channel to which the television is currently tuned based on a detected frequency. Additional source identification devices, such as on-screen readers and light-emitting-diode (LED) display readers, may be provided, for example, to determine if the television is operating (i.e., is turned ON) and/or the channel to which the television is tuned. A people counter may be located in the viewing space of the television and in communication with the home unit, thereby enabling the home unit to detect the identities and/or number of the persons currently viewing programs displayed on the television.

The home unit usually processes the inputs (e.g., channel tuning information, viewer identities, etc.) from the attachments to produce viewing records. Viewing records may be generated on a periodic basis (e.g., at fixed time intervals) or may be generated in response to one or more predetermined events, such as a full memory, or a change in an input, such as a change in the identities of the persons viewing the television, a change in the channel tuning information (i.e., a channel change), etc. Each viewing record typically contains channel information, such as a channel number and/or station identification (ID), and a time (e.g., a date and time-of-day) at which the channel was displayed. In cases in which the program content being displayed is associated with a local audio/video content delivery device, such as a digital video disk (DVD) player, a digital video recorder (DVR), a video cassette recorder (VCR), etc., the viewing records may include content identification (i.e., program identification) information as well as information relating to the time and manner in which the associated content was displayed. Viewing records may also contain additional information, such as the number of viewers present at the viewing time.

The home unit typically collects a quantity of viewing records and periodically (e.g., daily) transmits the collected viewing records to a central office or data processing facility for further processing or analysis. The central data processing facility receives viewing records from home units located in some or all of the statistically selected households and analyzes the viewing records to ascertain the viewing behaviors of households in a geographic area or market of interest, a particular household and/or a particular group of households selected from all participating households. Additionally, the central data processing facility may generate metering statistics and other parameters indicative of viewing behavior associated with some or all of the participating households. This data may be extrapolated to reflect the viewing behaviors of markets and/or regions modeled by the statistically selected households.

To generate viewing behavior information from viewing records, the central office or data processing facility may compare reference data, such as a list of programs (e.g., a schedule of television programming or a television guide), to the viewing records. In this manner, the central office can infer which program was displayed by cross-referencing the time and channel information in a viewing record to the program associated with that same time and channel in the program schedule. Such a cross-referencing process can be carried out for each of the viewing records received by the central office, thereby enabling the central office to reconstruct which programs were displayed by the selected households and the times at which the programs were displayed. Of course, the aforementioned cross-referencing process is unnecessary in systems in which the identity of the program is obtained by the home unit and contained in the viewing record.

The rapid development and deployment of a wide variety of audio/video content delivery and distribution platforms has dramatically complicated the home unit task of providing viewing records or information to the central data collection facility. For instance, while the above-mentioned frequency detector device can be used to detect channel information at a site where network television broadcasts are being displayed (because, under normal operation conditions, the local oscillator frequency corresponds to a known network channel), such a device typically cannot be used with digital broadcast systems. In particular, digital broadcast systems (e.g., satellite-based digital television systems, digital cable systems, etc.) typically include a digital receiver or set-top box at each subscriber site. The digital receiver or set-top box demodulates a multi-program data stream, parses the multi-program data stream into individual audio and/or video data packets, and selectively processes those data packets to generate an audio/video signal for a desired program. The audio and/or video output signals generated by the set-top box can be directly coupled to an audio/video input of an output device (e.g., a television, a video monitor, etc.) As a result, the local oscillator frequency of the output device tuner, if any, does not necessarily identify the channel or program currently being displayed.

To allow generation of meaningful viewing records in cases wherein, for example, the network channel is not readily identifiable or may not uniquely correspond to a displayed program, metering techniques based on the use of ancillary codes and/or content signatures may be employed. Metering techniques that rely on ancillary codes often encode and embed identifying information (e.g., a broadcast/network channel number, a program identification code, a broadcast time stamp, a source identifier to identify a network and/or station providing and/or broadcasting the content, etc.) in the broadcast signal such that the code is not noticed by the viewer. For example, a well-known technique used in television broadcasting involves embedding the ancillary codes in the non-viewable vertical blanking interval of the video signal. Another example involves embedding the ancillary codes in non-audible portions of the audio signal accompanying the broadcast program. This latter technique is especially advantageous because the ancillary code may be reproduced by, for example, the television speaker and non-intrusively monitored by an external sensor, such as a microphone.

In general, signature-based program identification techniques use one or more characteristics of the currently displayed (but not yet identified) audio/video content to generate a substantially unique proxy or signature (e.g., a series of digital values, a waveform, etc.) for that content. The signature information for the content being displayed may be compared to a set of reference signatures corresponding to a known set of programs. When a substantial match is found, the currently displayed program content can be identified with a relatively high probability.

While the known apparatus and techniques described above are well-suited for generating viewing records associated with live viewing of broadcast television programming, they may not be directly applicable to the generation of viewing records associated with video-on-demand (VOD) programs. In a VOD system, a subscriber may select among a potentially large collection of programming content to be transmitted to the specific subscriber's home for immediate viewing or for viewing at a later time. Thus, existing metering techniques based on cross-referencing a predetermined broadcast programming guide or television listing are not applicable because the content to be transmitted to the subscriber's home is not known prior to when the subscriber makes the selection. Thus, existing techniques would require a computationally expensive brute-force search over all possible reference broadcast and VOD content to determine the specific VOD content being consumed at the subscriber's home (because existing metering techniques typically do not distinguish whether the source of the consumed programming content is a broadcast or a VOD source). Moreover, the existing metering techniques may not be able to distinguish between content that may be provided by both a broadcast provider and a VOD provider and, as such, may incorrectly credit the source of the consumed programming content.

### BRIEF DESCRIPTION OF THE DRAWINGS

FIG. 1 is a block diagram of an example local metering system coupled to an example home entertainment system.

FIG. 2 is a block diagram of an example broadcast system and an example monitoring system.

FIG. 3 is a block diagram of an example monitoring system for video-on-demand (VOD) programming that may employ metered data from a VOD server and/or a statistically selected home.

FIG. 4 is a block diagram of an example monitoring system for VOD programming that may employ back-channel monitoring of a VOD provider.

FIG. 5 is a block diagram of an example monitoring system for VOD programming that may employ metered data from a subscriber set-top box (STB).

FIG. 6 is a block diagram of an example monitoring system for VOD programming that may employ metered data from an on-screen display reader (OSDR).

FIG. 7 is a block diagram of an example monitoring system for VOD programming that may employ broadcast channel monitoring and/or back-channel monitoring of an STB.

FIG. 8 is a block diagram of an example monitoring system for VOD programming that may employ metadata to monitor viewing of VOD content.

FIG. 9 is a flowchart of an example process for monitoring VOD programming that may employ metered data from a VOD server.

FIG. 10 is a flowchart of an example process for monitoring VOD programming that may employ back-channel monitoring of a VOD provider.

FIG. 11 is a flowchart of an example process for monitoring VOD programming that may employ software meter data from an STB.

FIG. 12 is a flowchart of an example process for monitoring VOD programming that may employ monitoring the internal operation of a STB.

FIG. 13 is a flowchart of an example process for monitoring VOD programming that may employ STB reporting directly to a central facility.

FIG. 14 is a flowchart of an example process for monitoring VOD programming that may employ metered data from an OSDR.

FIG. 15 is a flowchart of an example process for monitoring VOD programming that may employ broadcast channel monitoring and/or back-channel monitoring of an STB.

FIG. 16 is a flowchart of an example process for monitoring VOD programming that may employ metered data from a VOD server and/or a statistically selected home.

FIGS. 17A and 17B are flowcharts of example processes for monitoring VOD programming that may employ metadata to monitor viewing of VOD content.

FIG. 18 is a flowchart of an example process for monitoring VOD programming that may employ a combination of metered data from an STB and from an OSDR.

FIG. 19 is a flowchart of an example process for monitoring VOD programming that may employ a combination of metered data from an STB and/or an OSDR with generated content signatures to monitor viewing of VOD content.

FIG. 20 is a flowchart of an example process for monitoring VOD programming that may employ a combination of metered data from an STB and/or an OSDR with ancillary codes to monitor viewing of VOD content

FIGS. 21A and 21B are flowcharts of example processes for monitoring VOD programming that may employ a combination of metadata and metered data from a subscriber site to monitor viewing of VOD content.

FIG. 22 illustrates an example viewing record generated by the local metering system of FIG. 1.

FIG. 23 is a flowchart of a first example process to monitor VOD programming that may employ metered data from a VOD server and a statistically selected home.

FIG. 24 is a flowchart of a second example process to monitor VOD programming that may employ metered data from a VOD server and a statistically selected home.

FIGS. 25A-25C are a flowchart representative of example machine readable instructions which may be executed by a machine to generate VOD metering data based on information from the VOD server of FIG. 3.

FIGS. 26A-26G illustrate example VOD server information packets that may be generated by the example program represented by the flowchart of FIGS. 25A-25C.

FIG. 27 is a block diagram of an example computer that may be used to implement the example program represented by the flowchart of FIGS. 25A-25C.

### DETAILED DESCRIPTION

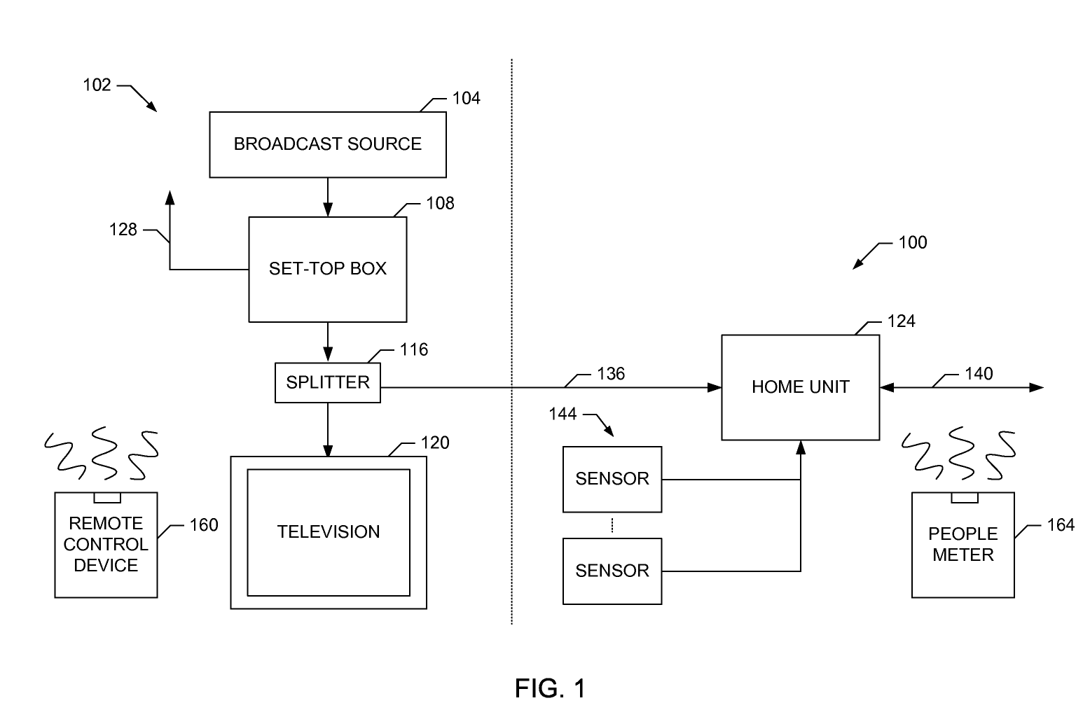

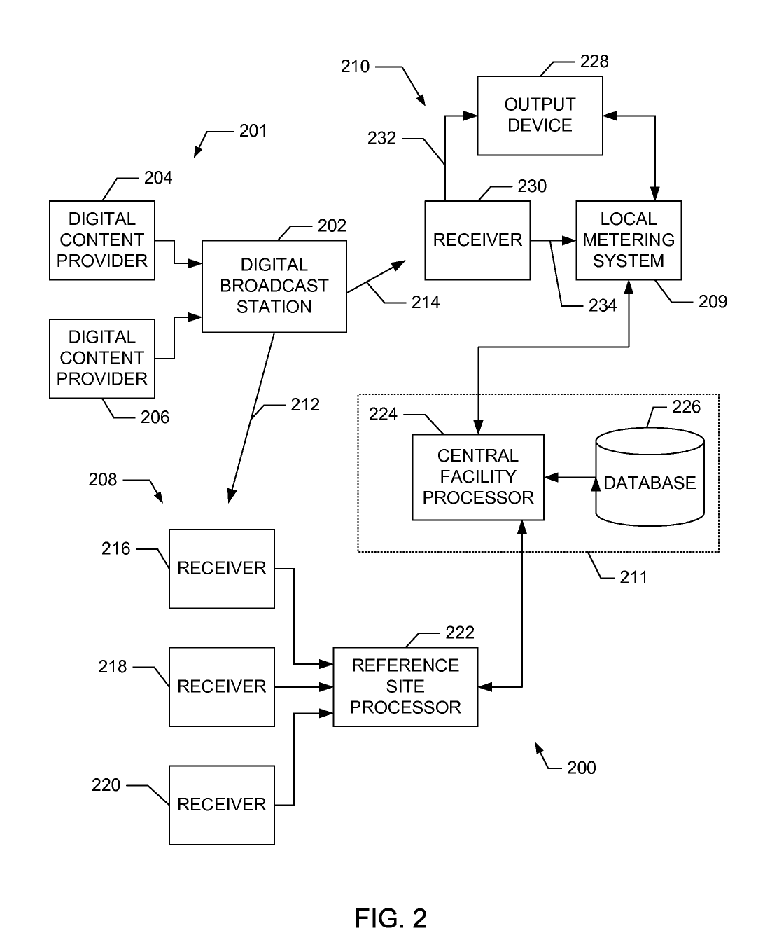

A block diagram of an example local metering system 100 capable of providing viewing and metering information for video-on-demand program content via an example home entertainment system 102 is illustrated in FIG. 1. The example home entertainment system 102 includes a broadcast source 104, a set-top box (STB) 108, a signal splitter 116 and a television 120. The example local metering system 100 includes a home unit 124. The components of the home entertainment system 102 and the local metering system 100 may be connected in any well-known manner including that shown in FIG. 1. For example, in a statistically selected household having one or more home entertainment systems 102, the home unit 124 may be implemented as a single home unit and one or more site units. In such a configuration, the single home unit performs the functions of storing data and forwarding the stored data to a central facility (such as the central facility 211 of FIG. 2 discussed below) for subsequent processing. Each site unit is coupled to a corresponding home entertainment system 102 and performs the functions of collecting viewing/metering data, processing such data (possibly in real-time) and sending the processed data to the single home unit for that home. The home unit receives and stores the data collected by the site units and subsequently forwards that collected data to the central facility.

The broadcast source 104 may be any broadcast media source, such as a cable television service provider, a satellite television service provider, a radio frequency (RF) television service provider, an internet streaming video/audio provider, etc. The broadcast source 104 may provide analog and/or digital television signals to the home entertainment system 102, for example, over a coaxial cable or via a wireless connection.

The STB 108 may be any set-top box, such as a cable television converter, a direct broadcast satellite (DBS) decoder, a video cassette recorder (VCR), etc. The set-top box 108 receives a plurality of broadcast channels from the broadcast source 104. Typically, the STB 108 selects one of the plurality of broadcast channels based on a user input, and outputs one or more signals received via the selected broadcast channel. In the case of an analog signal, the STB 108 tunes to a particular channel to obtain programming delivered on that channel. For a digital signal, the STB 108 may tune to a channel and decode certain packets of data to obtain programming delivered on a selected channel. For example, the STB 108 may tune to a major channel and then extract a program carried on a minor channel within the major channel via the decoding process mentioned above. For some home entertainment systems 102, for example, those in which the broadcast source 104 is a standard RF analog television service provider or a basic analog cable television service provider, the STB 108 may not be present as its function is performed by a tuner in the television 120.

An output from the STB 108 is fed to a signal splitter 116, such as a single analog y-splitter in the case of an RF coaxial connection between the STB 108 and the television 120 or an audio/video splitter in the case of a direct audio/video connection between the STB 108 and the television 120. (For configurations in which the STB 108 is not present, the broadcast source 104 may be coupled directly to the signal splitter 116). In the example home entertainment system 102, the signal splitter produces two signals indicative of the output from the STB 108. Of course, a person of ordinary skill in the art will readily appreciate that any number of signals may be produced by the signal splitter 116.

The STB 108 may also be coupled to a back-channel connection 128 to provide a return communication path to the broadcast signal provider corresponding to the broadcast source 104. The STB 108 may use the back-channel connection 128 to send billing and/or status information to the broadcast provider. The back-channel connection 128 may also allow a subscriber to use the STB 108 to request/order content for viewing on the television 120 (e.g., pay-per-view movies, video-on-demand programming, etc.), purchase goods and/or services, modify the subscription package associated with the STB 108, etc.

In the illustrated example, one of the two signals from the signal splitter 116 is fed to the television 120 and the other signal is delivered to the home unit 124. The television 120 may be any type of television or television display device. For example, the television 120 may be a television and/or display device that supports the National Television Standards Committee (NTSC) standard, the Phase Alternating Line (PAL) standard, the Système Électronique pour Couleur avec Mémoire (SECAM) standard, a standard developed by the Advanced Television Systems Committee (ATSC), such as high definition television (HDTV), a standard developed by the Digital Video Broadcasting (DVB) Project, or may be a multimedia computer system, etc.

The second of the two signals from the signal splitter 116 (i.e., the signal carried by connection 136 in FIG. 1) is coupled to an input of the home unit 124. The home unit 124 is a data logging and processing unit that may be used to generate viewing records and other viewing information useful for determining viewing and other metering information. The home unit 124 typically collects a set of viewing records and transmits the collected viewing records over a connection 140 to a central office or data processing facility (not shown) for further processing or analysis. The connection 140 may be a telephone line, a return cable television connection, an RF or satellite connection, an internet connection or the like.

The home unit 124 may be configured to determine identifying information based on the signal corresponding to the program content being output by the STB 108. For example, the home unit 124 may be configured to decode an embedded ancillary code in the signal received via connection 136 that corresponds to the program currently being delivered by the STB 108 for display on the television 120. Alternatively or additionally, the home unit 124 may be configured to generate a program signature based on the signal received via connection 136 that corresponds to the program currently being delivered by the STB 108 for display on the television 120. The home unit may then add this program identifying information to the viewing records corresponding to the currently displayed program.

To facilitate the determination of program identifying information and the generation of viewing records for the currently displayed program content, the home unit 124 may also be provided with one or more sensors 144. For example, one of the sensors 144 may be a microphone placed in the proximity of the television 120 to receive audio signals corresponding to the program being displayed. The home unit 124 may then process the audio signals received from the microphone 144 to decode any embedded ancillary code(s) and/or generate one or more audio signatures corresponding to a program being displayed. Another of the sensors 144 may be an on-screen display detector for capturing images displayed on the television 120 and processing regions of interest in the displayed image. The regions of interest may correspond, for example, to a broadcast channel associated with the currently displayed program, a broadcast time associated with the currently displayed program, a viewing time associated with the currently displayed program, etc. An example on-screen display detector is disclosed by Nelson, et al. in U.S. Provisional Patent Application Ser. No. 60/523,444 which is hereby incorporated by reference. Yet another of the sensors 144 could be a frequency detector to determine, for example, the channel to which the television 120 is tuned. One having ordinary skill in the art will recognize that there are a variety of sensors 144 that may be coupled with the home unit 124 to facilitate generation of viewing records containing sufficient information for the central office to determine a set of desired ratings and/or metering results.

The example home entertainment system 102 also includes a remote control device 160 to transmit control information that may be received by any or all of the STB 108, the television 120 and the home unit 124. One having ordinary skill in the art will recognize that the remote control device 160 may transmit this information using a variety of techniques, including, but not limited to, infrared (IR) transmission, radio frequency transmission, wired/cabled connection, and the like.

The example local metering system 100 also includes a people meter 164 to capture information about the audience. The example people meter 164 may have a set of input keys, each assigned to represent a single viewer, and may prompt the audience members to indicate that they are present in the viewing audience by pressing the appropriate input key. The people meter 164 may also receive information from the home unit 124 to determine a time at which to prompt the audience members. Moreover, the home unit 124 may receive information from the people meter 164 to modify an operation of the home unit 124 (such as causing the home unit to generate one or more viewing records based on a change in the viewing audience). As will be appreciated by one having ordinary skill in the art, the people meter 164 may receive and/or transmit information using a variety of techniques, including, but not limited to, infrared (IR) transmission, radio frequency transmission, wired/cabled connection, and the like. As will also be appreciated by one having ordinary skill in the art, the people meter 164 may be implemented by a combination of the remote control device 160 and one or more of the STB 108 and/or the home unit 124. In such an implementation, the STB 108 and/or the home unit 124 may be configured to display prompting information and/or other appropriate people meter content directly on the television 120. Correspondingly, the remote control device 160 may be configured to accept inputs from the viewing audience and transmit these user inputs to the appropriate device responsible for generating the people meter display on the television 120.

FIG. 2 illustrates an example monitoring system 200 to monitor viewing of program content provided by an example broadcast system 201. The example broadcast system 201 of FIG. 2 includes a broadcast station 202 that receives audio/video content from a plurality of content providers 204 and 206. The audio/video content providers 204 and 206 may provide audio and/or video programs or information, such as television programs, advertisements, audio (e.g., radio) programs, still image information (e.g., web pages), etc., in known manners to the broadcast station 202.

The example monitoring system 200 of FIG. 2 includes one or more reference sites 208, a plurality of local metering systems 209 (for example, a set of systems similar or identical to the local metering system 100 of FIG. 1) located at a plurality of home sites 210 (which may be statistically selected to represent a larger population) and a central facility 211 to compile and process data collected by the local metering systems 209. For ease of reference, only one home site 210, one reference site 208 and one central facility 211 is shown in FIG. 2. However, persons of ordinary skill in the art will appreciate that any number of home sites 210, reference sites 208 and/or central data collection and processing facilities 211 may be employed.

The broadcast station 202 transmits one or more signals containing digital and/or analog audio/video content information. These signals are received by at least one reference site 208 and at least one statistically selected home site 210 via communication paths or links 212 and 214, respectively. The communication paths or links 212 and 214 may include any combination of hardwired or wireless links, such as satellite links, wireless land-based links, cable links, etc. The signals conveyed via the links 212 and 214 may contain multi-program analog signals and/or digital data streams which are commonly employed within existing broadcast systems.

In the example monitoring system 200, the reference site 208 includes a plurality of receivers (e.g., set-top boxes or the like) 216, 218 and 220 that simultaneously demodulate, demultiplex and/or decode audio, video and/or other information received from the broadcast station 202. In the illustrated example, each of the receivers 216, 218 and 220 provides audio and/or video information associated with a different program that is currently being broadcast to a reference site processor 222. In other words, the receiver 216 may provide audio and/or video information associated with a program A while the receivers 218 and 220 provide audio and/or video information associated with respective programs B and C. In addition, the reference site processor 222 is configured to control each of the receivers 216, 218 and 220 and/or has information indicating a program to which each of the receivers 216, 218 and 220 is tuned at any given time.

The reference site processor 222 may determine the original broadcast date/time stamps, decode reference ancillary code information and/or generate reference signature information for a plurality of simultaneously broadcast audio/video content. The reference site processor 222 sends the original broadcast time stamps and the reference code and/or signature information to a central facility processor 224 which stores the original broadcast time stamps and the reference code and/or signature information in a database 226.

The home site 210 could be, for example, a statistically selected home containing a television, a radio, a computer, etc. The home site 210 includes an output device 228 (e.g., a video display, speaker, etc., such as the television 120 of FIG. 1). The home site 210 also includes a receiver 230, such as the STB 108 of FIG. 1, which may be similar or identical to the receivers 216, 218 and 220. Such receivers are well-known and, thus, are not described in greater detail herein. The receiver 230 provides audio and/or video signals 232 to the output device 228 that are used to present the program currently selected for consumption.

To monitor the use of the receiver 230, the home site 210 is provided with a local metering system 209, such as the local metering system 100 of FIG. 1. The local metering system 209 may include, for example, a home unit such as the home unit 124. The receiver 230 provides an audio and/or a video signal containing audio and/or video information associated with the currently displayed program to the local metering system 209 via a connection 234. The local metering system 209 uses the signal received via the connection 234 to decode ancillary code information and/or generate signature information corresponding to the program currently being displayed on the output device 228. The local metering system 209 stores and periodically conveys this code and/or signature information to the central facility processor 224, for example, in the form of a viewing record or set of records.

The central facility processor 224, in addition to being able to perform other processing tasks, is configured to compare code and/or signature information generated at the home site 210 to the reference code and/or signature information stored in the database 226 to identify the channels and/or programs that were displayed at the home site 210. To facilitate the comparison of code and/or signature information received from the reference site 208 to the code and/or signature information received from the home site 210, the reference site processor 222 and the local metering system 209 may generate time stamp information and associate such time stamp information with the code and/or signature information collected at the corresponding time. In this manner, the central facility processor 224 can attempt to align the code and/or signature information received from the reference sites 208 with the code and/or signature information collected at the corresponding times via the home site 210 to thereby reduce the number of comparisons required to identify a match.

As mentioned previously, existing content metering techniques may not be suitable for monitoring viewing of video-on-demand (VOD) programming content. For example, a broadcast programming guide (or equivalent mapping of content to broadcast time) is generally not available in the case of VOD programming. Moreover, similar programming content may be available from both a VOD server and another broadcast source (e.g., another broadcast station, cable channel, etc.). In the latter case, the existing content metering approaches may not be able to distinguish the source of the consumed content and, therefore, may generate erroneous crediting results. Thus, it is desirable to determine if the consumed content is being provided by a VOD source and/or to narrow the universe of possible programming content that is cross-referenced to match the consumed content with a known reference. Methods and apparatus to address at least some of these limitations are discussed in the following figure descriptions. A particular method and/or apparatus may be preferred depending on the capabilities of the multiple service operator (MSO) providing the VOD service, the characteristics of the equipment used to implement the VOD system, the access to data stored in and/or generated by the VOD server(s), the access to data and/or operational information corresponding to the subscriber STB (e.g., the STB 108 of FIG. 1), etc.

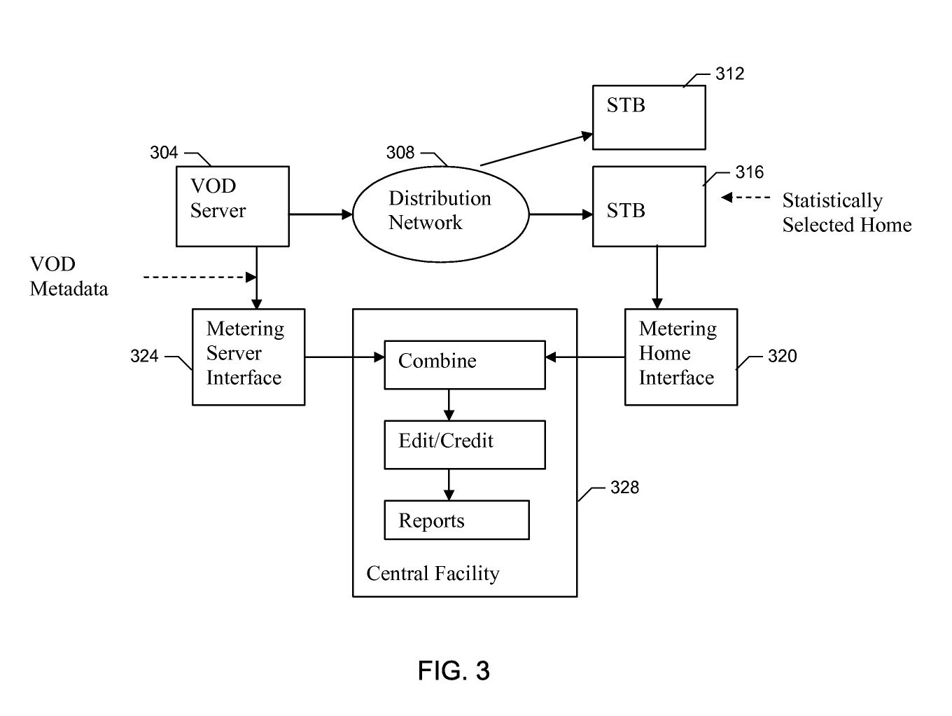

FIG. 3 illustrates an example monitoring system for video-on-demand (VOD) programming that may employ metered data from a VOD server and/or a statistically selected home. In the example environment of use of FIG. 3, the VOD system includes a VOD server 304, a distribution network 308 and multiple subscriber STBs 312, 316. The VOD server 304 may be implemented as a single server or a collection of servers located in a central location or multiple, distributed geographical locations. The VOD server 304 stores the VOD content to be transmitted to the subscriber STBs 312, 316. The distribution network 308 may be any distribution network that is able to transmit VOD content to a subscriber location (e.g., an RF television broadcaster, a cable television service provider, a satellite service provider, etc.). For example, the distribution network 308 may be implemented by the broadcast station 202 and the communication paths 212 and 214 of FIG. 2. The subscriber STBs 312, 316 may be any set-top box, such as the STB 108 of FIG. 1.

The example monitoring system of FIG. 3 includes a metering home interface 320, such as the local metering system 100 of FIG. 1, coupled to the STB 316. The metering home interface 320 may be used to collect viewing data (e.g., TV ON/OFF data, tuning data, content codes, content signatures, etc.), audience demographics (e.g., via the people meter 164), etc. The example monitoring system also includes a metering server interface 324 to collect data from the VOD server 304. The data may be stored in any appropriate format, for example, an XML format or equivalent, and may include VOD content information, such as the VOD content title, the associated metadata for the VOD content and other subscriber information, such as an STB identifier (ID) for a given subscriber's STB. The metered server data may correspond to all VOD service subscribers, instead of being limited to only those subscribers included in a statistical sampling of selected households.

The example monitoring system of FIG. 3 also includes a central facility 328, such as the central facility 211 of FIG. 2. The central facility 328 may receive information from the metering server interface 324 and/or the metering home interface 320. The central facility 328 may combine the information received from both the metering server interface 324 and/or the metering home interface 320 to credit VOD programming and to generate corresponding usage and demographic reports. For example, the central facility 328 may use the STB ID for the STB 316 to match the data from metering home interface 320 to the corresponding data received from the metering server interface 324.

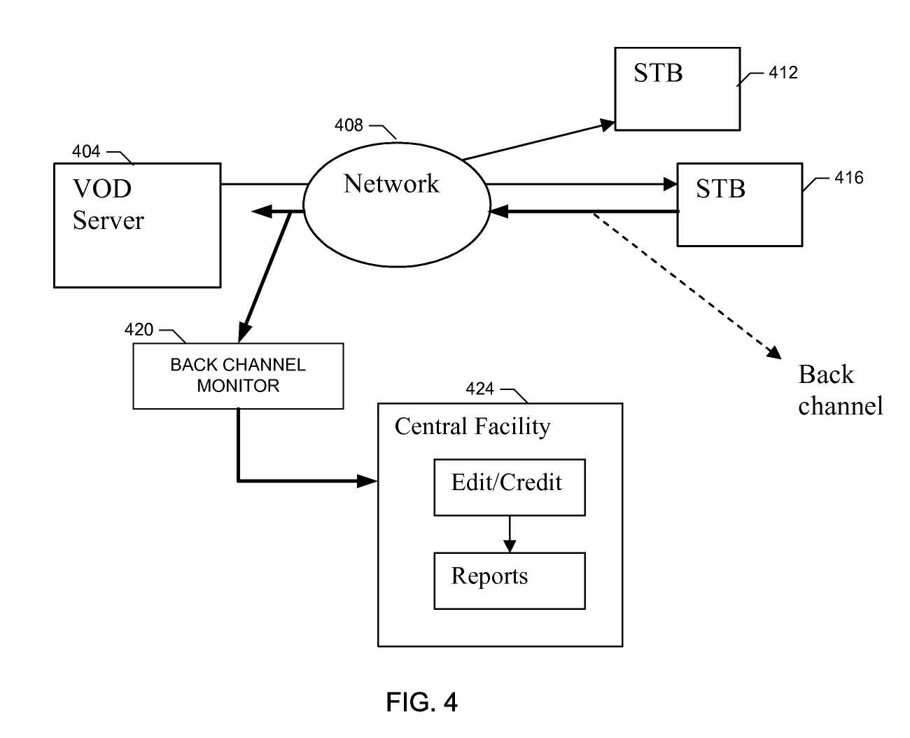

FIG. 4 illustrates an example monitoring system for VOD programming that may employ back-channel monitoring of a VOD provider. As for the example of FIG. 3, the example environment of use of FIG. 4 comprises a VOD system that includes a VOD server 404, a distribution network 408 and multiple subscriber STBs 412, 416. For brevity, the functionality of these elements is not re-described here. Rather, the interested reader is referred to the detailed description of the corresponding blocks in FIG. 3.

The example monitoring system of FIG. 4 includes a back-channel monitor 420 to monitor the information received by the VOD service provider via a back-channel connection, such as the back-channel connection 128 of FIG. 1. The back-channel monitor 420 may receive VOD-related information being transmitted by the STB 416 to the VOD service provider. This information may include subscriber requests to order VOD content, billing information, the STB ID corresponding to the STB 416, etc. The back-channel monitor 420 sends the collected back-channel information to a central facility 424, such as the central facility 211 of FIG. 2. The central facility 424 may use the reported back-channel information to credit viewing of a requested VOD program and to generate additional content metering reports.

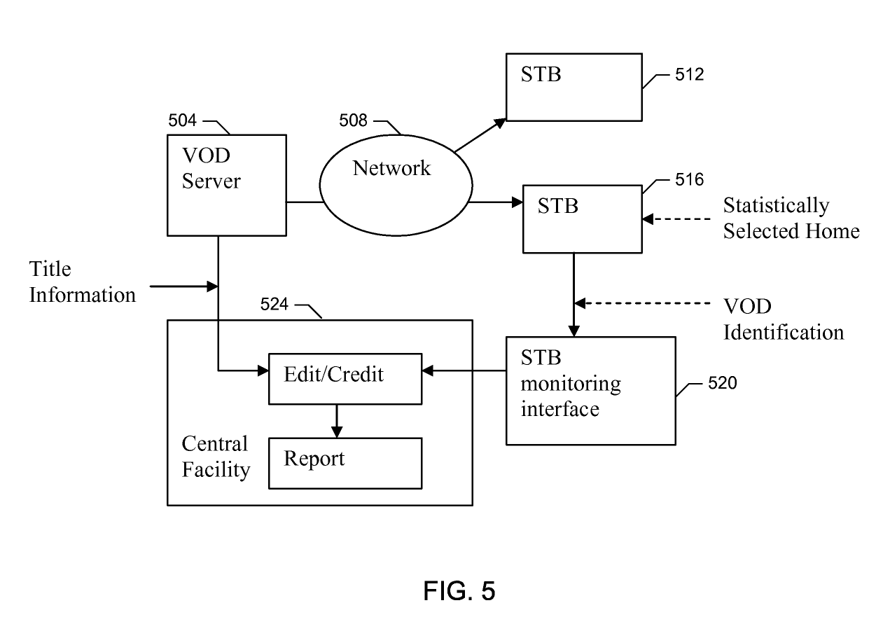

FIG. 5 illustrates an example monitoring system for VOD programming that may employ metered data from a subscriber set-top box (STB). As in the example of FIG. 3, the example environment of use of FIG. 5 comprises a VOD system that includes a VOD server 504, a distribution network 508 and multiple subscriber STBs 512, 516. For brevity, the functionality of these elements is not re-described here. Rather, the interested reader is referred to the detailed description of the corresponding blocks in FIG. 3.

The example monitoring system of FIG. 5 includes an STB monitoring interface 520 coupled to the STB 516. The STB monitoring interface may be implemented by a software meter running in the STB 516 to collect and report, for example, VOD usage data, coupled to a home unit, such as the home unit 124 of FIG. 1. An example software meter that could be adapted to implement the STB monitoring interface is described in, for example, PCT Application Serial No. PCT/US98/14286, entitled “Audience Measurement System for Digital Television” and filed on May 12, 1998. PCT Application Serial No. PCT/US98/14286 is hereby incorporated by reference in its entirety.

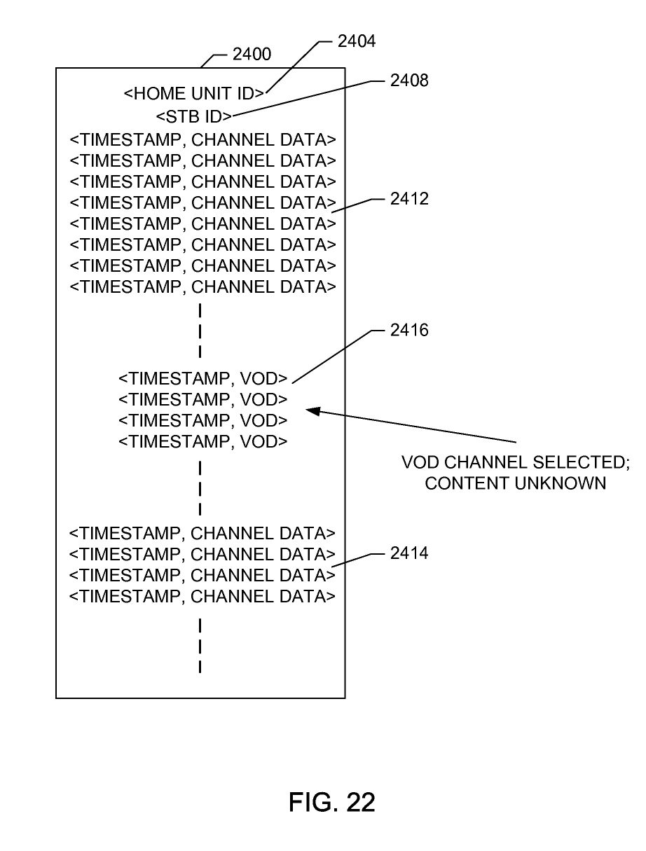

Alternatively or additionally, the STB monitoring interface 520 may be a device coupled to the internal communication buses and/or interfaces of the STB 516 (such as the communication buses and/or interfaces described in FIG. 22 below). In this case, the STB monitoring interface 520 may be configured to determine the operating state of the STB 516 based on the transactions monitored on the communications buses/interfaces. The STB monitoring interface 520 may also be configured to read and/or process data stored internally in the STB 516. Examples of memory/bus analyzers that could be adapted to implement the STB monitoring interface discussed herein are described in, for example, U.S. Pat. No. 5,488,408, entitled “Serial Data Channel Metering Attachment for Metering Channels to Which a Receiver is Tuned” and filed on Mar. 22, 1994, and PCT Application Serial No. PCT/US2002/038012, entitled “Apparatus and Methods for Tracking and Analyzing Digital Recording Device Event Sequences” and filed on Nov. 27, 2002. U.S. Pat. No. 5,488,408 and PCT Application Serial No. PCT/US2002/038012 are hereby incorporated by reference in their entirety.

The STB monitoring interface 520 sends collected metering data to a central facility 524. The collected metering data may include VOD activity information (e.g., an indication that a VOD virtual channel was selected), VOD identification information (e.g., the title of the VOD content as stored in memory within the STB 516), public content identifiers included in the VOD data bit stream (e.g., fields in an MPEG-2 data format), etc. The reported data may also include other viewing information (e.g., TV ON/OFF data, tuning data, content codes, content signatures, etc.), audience demographics (e.g., via the people meter 164), etc. The central facility 524 may also receive VOD title information from the VOD server 504 that may be used, for example, to further validate the information reported by the STB monitoring interface 520. As will be appreciated by someone of ordinary skill in the art, the monitoring system of FIG. 5 may be particularly useful for monitoring VOD content that is downloaded and cached in a STB (e.g., the STB 516). The VOD content may then be presented by the STB at a present or later time based on a subscriber's authorization and/or payment of a viewing fee.

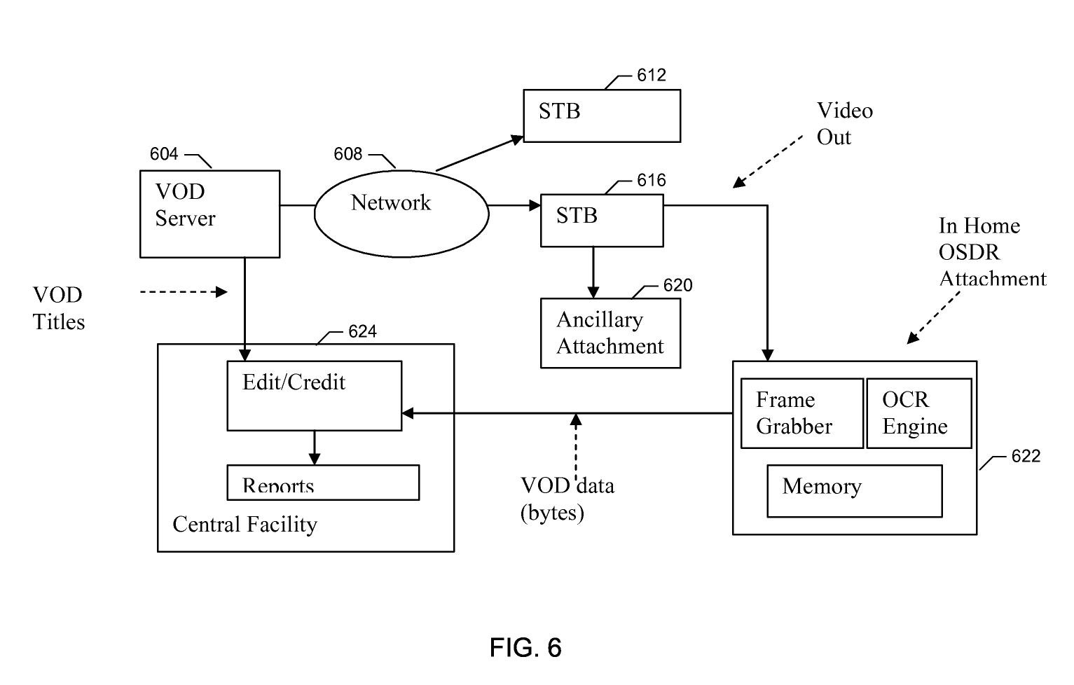

FIG. 6 illustrates an example monitoring system for VOD programming that may employ metered data from an on-screen display reader (OSDR). As in the example of FIG. 3, the example environment of use of FIG. 6 comprises a VOD system that includes a VOD server 604, a distribution network 608 and multiple subscriber STBs 612, 616. For brevity, the functionality of these elements is not re-described here. Rather, the interested reader is referred to the detailed description of the corresponding blocks in FIG. 3.

The example monitoring system of FIG. 6 includes an ancillary attachment 620 coupled to the STB 616. The ancillary attachment 620 may be implemented by a home unit, such as the home unit 124 of FIG. 1, to monitor, for example, whether the STB 616 has selected a VOD virtual channel over which VOD content may be received. Additionally, the example monitoring system includes an on-screen device reader (OSDR) 622 coupled to the STB 616. The example OSDR 622 includes a framegrabber and optical character recognition (OCR) engine to capture video screenshots corresponding to the output of the STB 616 and process such screenshots to determine viewing-related information. For example, the OSDR 622 may be used to capture VOD channel and/or title information from the video signal output by the STB 616. The OSDR may also be used to capture other viewing-related information from the screenshot (e.g., displaying of a viewing guide, entering an audio mute state, etc.). An example OSDR is disclosed by Nelson, et al. in U.S. Provisional Patent Application Ser. No. 60/523,444 which was previously incorporated by reference.

The OSDR 622 (possibly in conjunction with a home unit, such as the home unit 124 of FIG. 1) sends collected metering data to a central facility 624. The collected metering data may include VOD activity information (e.g., an indication that a VOD virtual channel was selected as determined by the ancillary attachment 620), VOD identification information (e.g., the title of the VOD content as determined by the OSDR 622), etc. The reported data may also include other viewing information (e.g., TV ON/OFF data, tuning data, content codes, content signatures, etc.), audience demographics (e.g., via the people meter 164), etc. The central facility 624 may also receive VOD title information from the VOD server 604 that may be used, for example, to further validate the information reported by the OSDR 622 (and an associated home unit 124 if present).

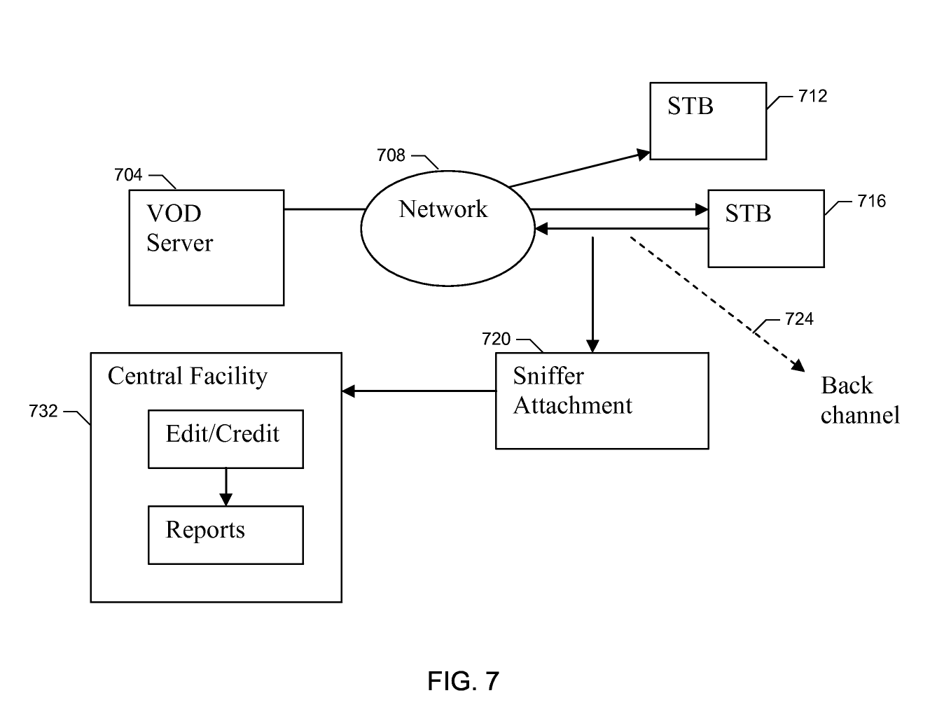

FIG. 7 illustrates an example monitoring system for VOD programming that may employ broadcast channel monitoring and/or back-channel monitoring of an STB. As in the example of FIG. 3, the example environment of use of FIG. 7 comprises a VOD system that includes a VOD server 704, a distribution network 708 and multiple subscriber STBs 712, 716. For brevity, the functionality of these elements is not re-described here. Rather, the interested reader is referred to the detailed description of the corresponding blocks in FIG. 3.

The example monitoring system of FIG. 7 includes a monitoring device 720 coupled to the back-channel connection 724 from the STB 716. The back-channel connection 724 may be any type of network connection, e.g., a dial-up phone line connection, an internet connection (e.g., via an Ethernet, broadband and/or dial-up access provider), a cellular/wireless connection, etc. Although not shown, the monitoring device 720, also known as a “sniffer” attachment 720, or an additional monitoring device 720 may also be coupled to the broadcast source connection between the distribution network 708 and the STB 716. In the case of back-channel monitoring, the sniffer attachment 720 may be configured to process information transmitted from the STB 716 back to the VOD service provider (e.g., by monitoring and decoding transmitted Internet Protocol (IP) packets). This information may include subscriber requests to order VOD content, billing information, the STB ID corresponding to the STB 716, etc. In the case of broadcast connection monitoring, the sniffer attachment 720 may be configured to process information transmitted by the distribution network 708 to the STB 716 (e.g., by monitoring and decoding the digital data packets that are transmitted in a known/standardized format, such as MPEG-2). This information may include, for example, public content identifiers associated with the displayed VOD programming content.

The sniffer attachment 720 sends the collected back-channel and/or broadcast channel information to a central facility 732, such as the central facility 211 of FIG. 2. The central facility 732 may use the reported back-channel and/or broadcast channel information to credit viewing of a requested VOD program and to generate additional content metering reports. The central facility 732 may also receive VOD title information from the VOD server 704 that may be used, for example, to further validate the information reported by the sniffer attachment 720 (and an associated home unit 124 if present).

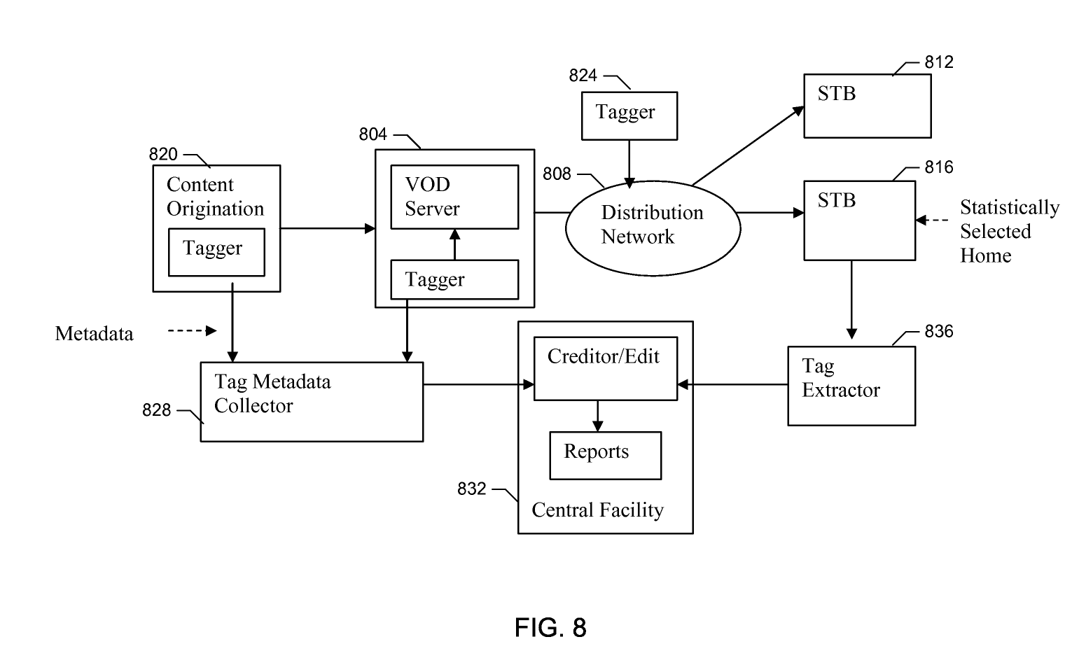

FIG. 8 is a block diagram of an example monitoring system for VOD programming that may employ metadata to monitor viewing of VOD content. As in the example of FIG. 3, the example environment of use of FIG. 8 comprises a VOD system that includes a VOD server 804, a distribution network 808 and multiple subscriber STBs 812, 816. For brevity, the functionality of these elements is not re-described here. Rather, the interested reader is referred to the detailed description of the corresponding blocks in FIG. 3.

The example monitoring system of FIG. 8 includes a number of tagger units 820 and 824. The tagger unit 820 may be used by a content provider to embed and/or generate metadata information for the VOD content to be stored in the VOD server 804. Such metadata information may include audio/video ancillary codes, audio/video signatures, digital content identifiers (IDs) (e.g., such as Aux Data private data supported by the AC3 audio standard), private content IDs (such as those supported by the MPEG-2 and/or AC3 standards), etc. The tagger unit 824 may also be included in the monitoring system to embed and/or generate additional metadata (e.g., an identifier for one or more distribution nodes used to store and route the VOD content to the subscriber site) corresponding to the VOD content as it is routed through the distribution network 808. Additionally or alternatively, the VOD server 804 may include tagger functionality to associate metadata with stored VOD content.

The example monitoring system of FIG. 8 also includes a tag metadata collector 828 to collect metadata information from any or all of the tagger unit 820, the tagger unit 824 and the VOD server 804. The metadata collector 828 provides the reported metadata to a central facility 832, such as the central facility 211 of FIG. 2. The central facility 832 may use the reported metadata to construct a reference database of possible VOD content and its associated metadata.

At the subscriber side, the example monitoring system of FIG. 8 includes a tag metadata extractor 836 coupled to the STB 816 (and/or an associated home unit, such as the home unit 124 of FIG. 1). The metadata extractor 836 may be configured to receive and/or process software meter data, internal bus transactions, internal data and/or the like from the STB 816. The metadata extractor 836 may also be configured to process the transmitted video/audio received by the STB 816 (e.g., via a splitter 116 as shown in FIG. 1). The metadata extractor 836 extracts and/or generates metadata corresponding to the VOD content received and output by the STB 816. For example, the metadata extractor 836 may extract the ancillary code, data content IDs and/or private content IDs embedded by the tagger units 820, 824 and/or the VOD server 804. Additionally or alternatively, the tag extractor 836 may generate audio/video signatures corresponding to the displayed VOD content.

After collection of the desired metadata, the tag extractor 836 (and/or a companion home unit 124 if present) sends the collected metadata to the central facility 832. The central facility 832 may cross-reference the reported metadata with the metadata contained in the reference database. The central facility 832 may then use the matched reference metadata to credit viewing of a requested VOD program and to generate additional content metering reports (e.g., based on additional metering information included in the metadata and/or additional viewing information and/or audience demographics reported by a home unit 124 located at the subscriber site).

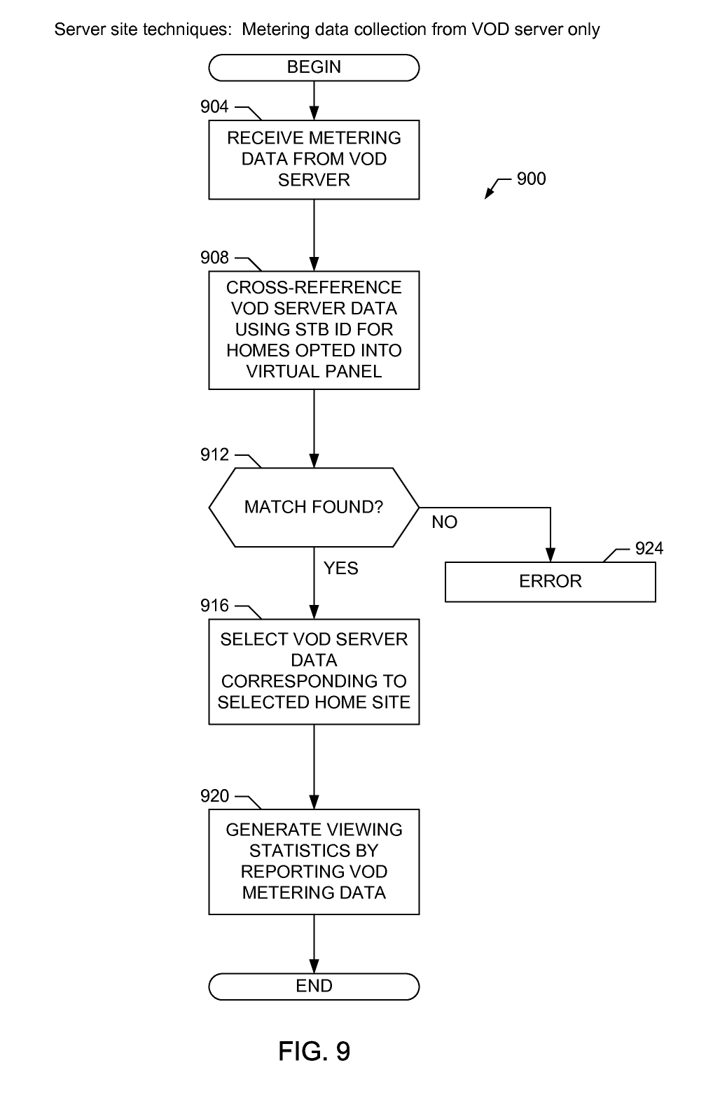

FIGS. 9 to 21 illustrate example processes to monitor and/or meter audience viewing of VOD programs. The illustrated processes may be implemented by the apparatus and/or systems (or combinations thereof) shown in FIGS. 1 to 8. As indicated previously, a particular process may be preferred depending on the capabilities of the MSO providing the VOD service, the characteristics of the equipment used to implement the VOD system, the degree of access to data stored in and/or generated by the VOD server(s), the degree of access to data and/or operational information corresponding to the subscriber STB (e.g., the STB 108 of FIG. 1), etc.

The example processes of FIGS. 9 to 12 may be classified into the following three (3) broad categories of metering techniques: A) server site techniques, B) home site techniques and C) hybrid techniques. Server site metering techniques attempt to meter the viewing of VOD content based on information from only the VOD server/provider side of the VOD system. Home site metering techniques attempt to meter the viewing of VOD content based on information from only the subscriber side of the VOD system. Hybrid metering techniques attempt to meter the viewing of VOD content based on information from either or both of the VOD server/provider side and the subscriber side of the VOD system.

A) Server Site Techniques:

FIG. 9 illustrates an example process 900 for monitoring VOD programming that may employ metered data from a VOD server. The example process 900 begins at block 904 when a database of metering data is received from a VOD server, such as the VOD server 304 of FIG. 3. The metering data may include, for example, VOD content titles, start/end times corresponding to the transmission of the VOD content, STB IDs corresponding to the subscriber STBs (e.g., STB 316) requesting the VOD content, etc. The process then cross-references the set of reported STB IDs against the STB IDs included in a statistically selected group of subscriber homes that are participating in the ratings/metering data collection (block 908). If a match is found at block 912, control proceeds to block 916 at which the process 900 extracts the reported VOD data corresponding to the selected STB ID. The process 900 then uses the extracted VOD server data to generate viewing statistics and crediting reports for the corresponding consumed VOD content (block 920). If a match is not found at block 912, control proceeds to block 924 at which the process 900 reports an error condition because no STB IDs corresponding to the set of statistically selected homes were found in the metering data provided by the VOD server at block 904.

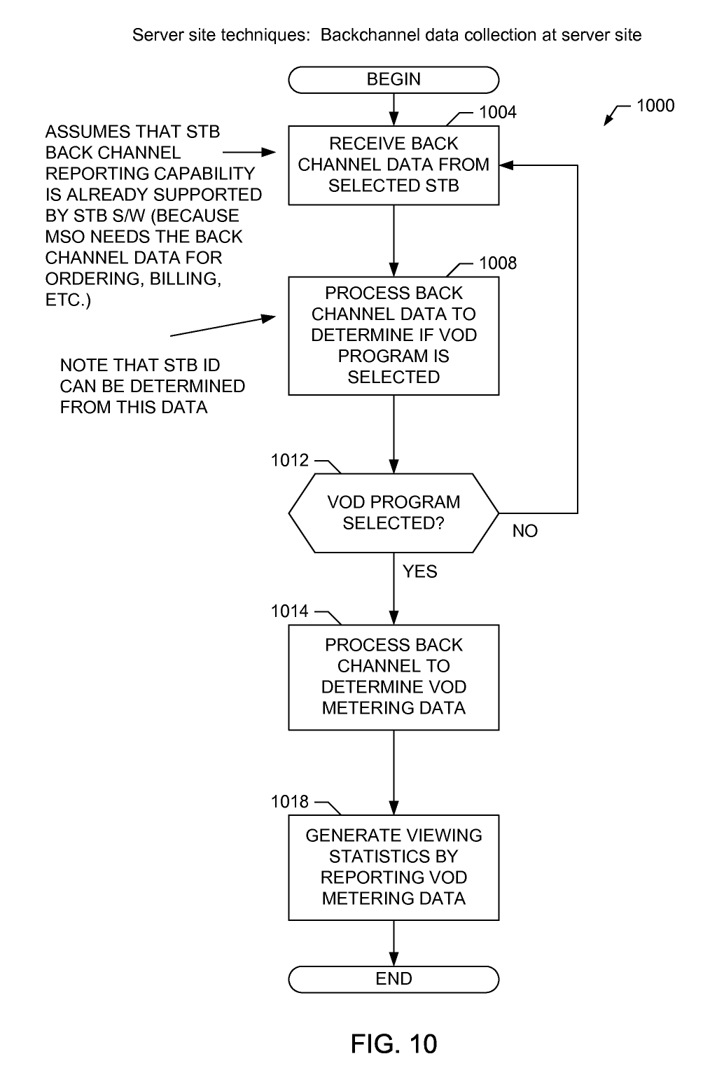

FIG. 10 illustrates an example process 1000 for monitoring VOD programming that may employ back-channel monitoring of a VOD provider. The example process 1000 may be used in VOD systems in which back-channel reporting by a subscriber STB (e.g., the STB 416 of FIG. 4) is already supported and enabled (e.g., to provide ordering requests, billing information, etc., to the MSO providing the VOD service). The process 1000 begins at block 1004 when back-channel data is received by the MSO/VOD provider (e.g., via a back-channel monitor 420). The process 1004 then analyzes the back-channel data to determine if a VOD program was selected by a subscriber (block 1008). If at block 1012 the process 1000 determines that a subscriber selected/ordered a VOD program, control proceeds to block 1014 at which the VOD data corresponding to the subscriber's STB ID is processed to extract the appropriate VOD metering data. Control then proceeds to block 1018. At block 1018 the extracted back-channel data is used to generate viewing statistics and/or crediting reports for the corresponding consumed VOD content. If at block 1012 the process 1000 determined that no subscriber selected/ordered VOD content, control returns to block 1004 and subsequent blocks thereto.

B) Home Site Techniques:

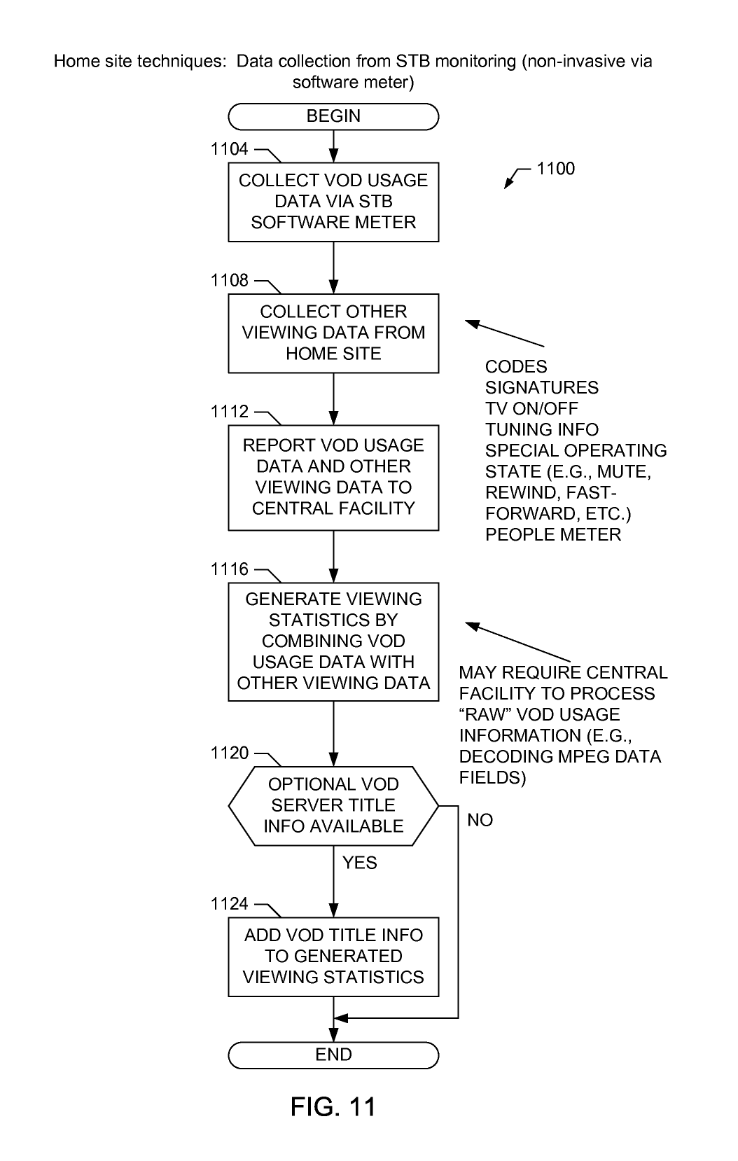

FIG. 11 illustrates an example process 1100 for monitoring VOD programming that may employ software meter data from an STB. The example process 1100 begins at block 1104 at which VOD usage information is collected from a subscriber STB (e.g., the STB 516 of FIG. 5). The process 1100 may collect such data via a STB monitoring interface 520 configured to process data generated by a software meter running in the STB 516. The collected VOD usage data may include VOD activity information (e.g., an indication that a VOD virtual channel was selected), VOD identification information (e.g., the title of the VOD content as stored in memory within the STB 516), public content identifiers included in the VOD data bit stream (e.g., fields in an MPEG-2 data format), etc. Control then proceeds to block 1108. At block 1108 additional viewing data is collected from the home site (e.g., embedded audio/video codes, generated audio/video signatures, television ON/OFF information, tuning information, special operating states such as mute, pause, rewind, fast-forward, etc., people meter audience statistics, etc.). The VOD usage data and other viewing data are then reported to a central facility, such as the central facility 524 of FIG. 5 (block 1112).

After the VOD usage and other viewing information are reported, control proceeds to block 1116. At block 1116, the reported data is used to generate viewing statistics and crediting reports for the corresponding consumed VOD content. To generate such statistics and reports, “raw” VOD usage data, (e.g., bit fields contained in an MPEG-2 data stream corresponding to the received VOD programming content) may be processed. If the process 1100 is configured to receive VOD content title information from the VOD server (e.g., the VOD server 504 of FIG. 5) (block 1120), control proceeds to block 1124. At block 1124, the provided VOD content title information is used to validate the crediting reports generated in block 1116.

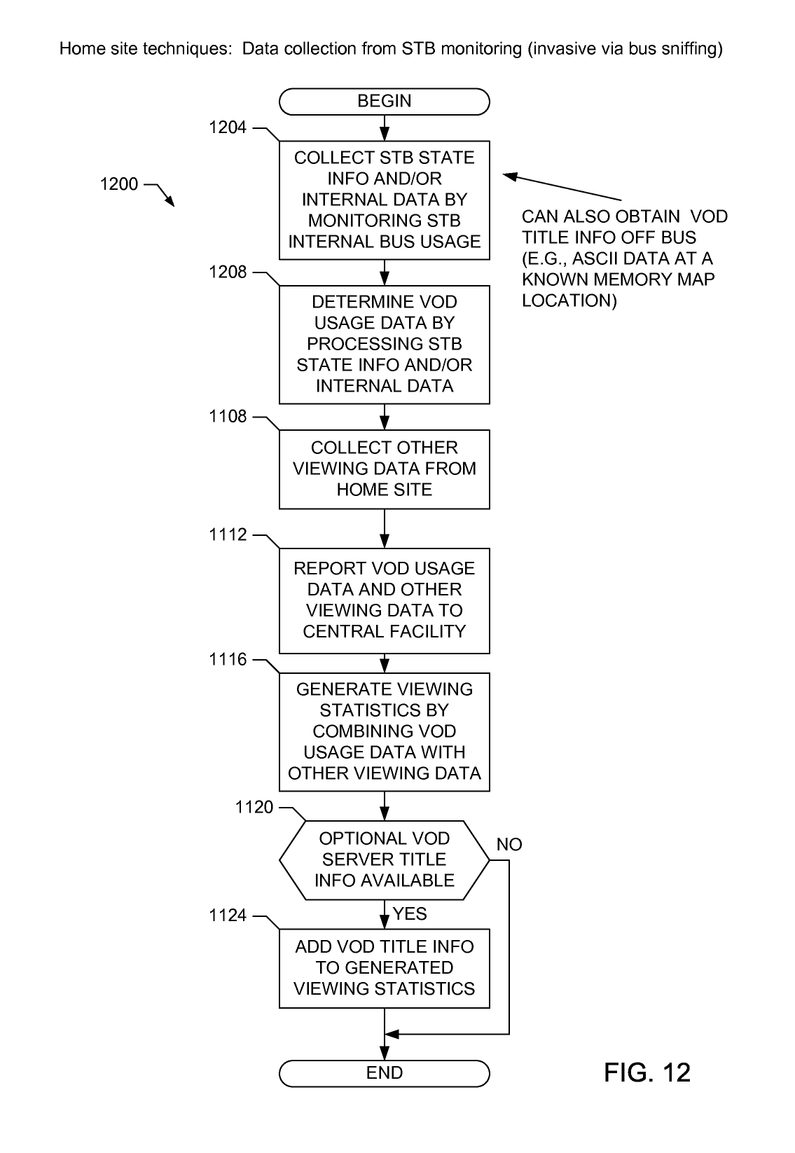

FIG. 12 illustrates an example process 1200 for monitoring VOD programming that may employ monitoring the internal operation of a STB. The example process 1200 begins at block 1204 at which state and/or other internal data/information is collected from a subscriber STB, such as the STB 516 of FIG. 5. The process 1200 may collect such information via a STB monitoring interface 520 that is coupled to the STB 516 and configured to monitor, for example, the internal bus transactions of the STB 516. The collected information may include, for example, VOD program requests, VOD content title information (e.g., read as ASCII data from a known memory map location), the STB ID corresponding to the STB 516, etc. Control then proceeds to block 1208 at which the collected STB state and/or other internal data is processed to determine VOD usage data (such as viewing of VOD program content, VOD content identifiers, etc.). Control then proceeds to block 1108.

Blocks 1108, 1112, 1116, 1120 and 1124 of process 1200 are substantially identical to the corresponding blocks in the process 1100 of FIG. 11. For brevity, these blocks will not be re-described here. Rather, the interested reader is referred to the description of FIG. 11 for a detailed discussion of the above-identified blocks.

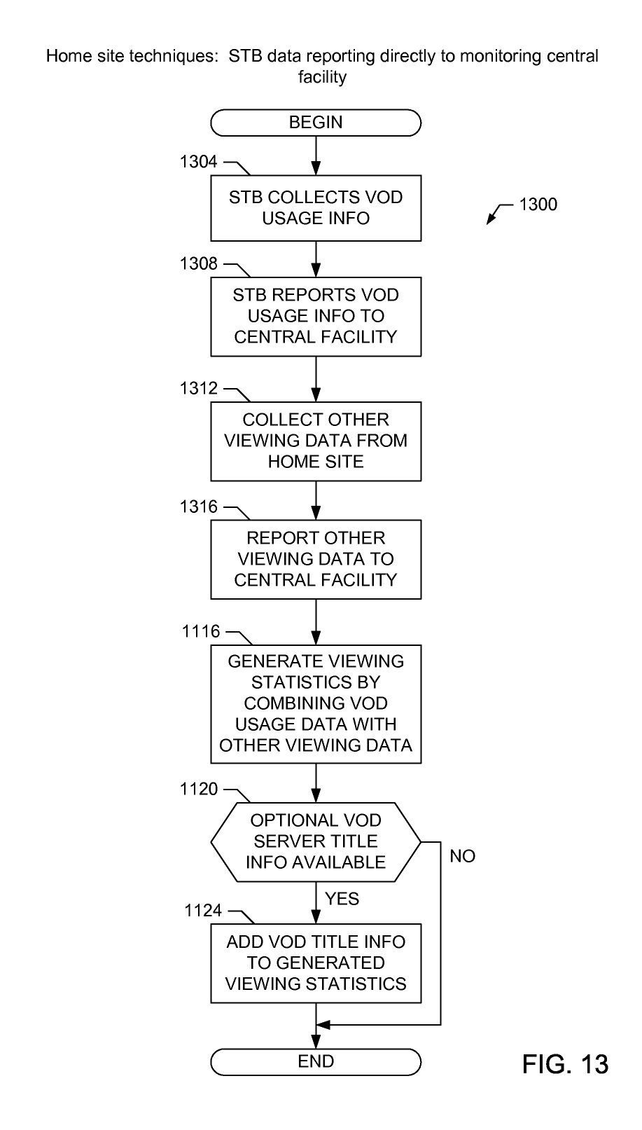

FIG. 13 illustrates an example process 1300 for monitoring VOD programming that may employ STB reporting directly to a central facility. The example process 1300 may be used in VOD systems in which the STB (such as the STB 108 of FIG. 1) is configured to report information directly to a monitoring central facility, such as the central facility 211 of FIG. 2. The example process 1300 begins when the STB 108 collects VOD usage information (block 1304). The STB 108 then reports such information directly to a central facility 211 (block 1308). Control then proceeds to block 1312 at which other viewing data may be collected as described above. The collected data may then be reported to the central facility 211 (block 1316). Control then proceeds to block 1116.

Blocks 1116, 1120 and 1124 of process 1300 are substantially identical to the corresponding blocks in the process 1100 of FIG. 11. For brevity, these blocks are not re-described here. Rather, the interested reader is referred to the description of FIG. 11 for a detailed discussion of the above-identified blocks.

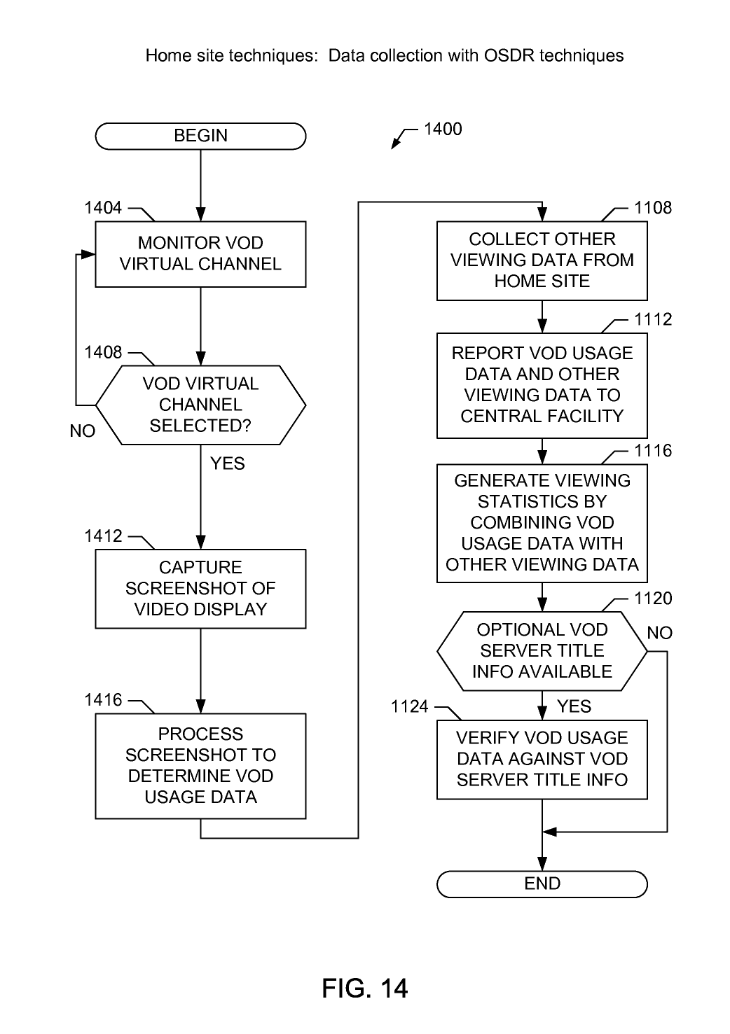

FIG. 14 illustrates an example process 1400 for monitoring VOD programming that may employ metered data from an OSDR. The example process 1400 may be used in VOD monitoring systems that include an OSDR, such as the OSDR 622 of FIG. 6. The example process 1400 begins at block 1404 at which a VOD virtual channel or set of virtual channels over which VOD programming content may be transmitted by the network 608 to the STB 616 is monitored. The virtual channel may be monitored using one of many known ancillary attachments 620 capable of determining the channel selected by the STB 616. If a VOD channel is not selected (block 1408), control returns to block 1404 to wait for a VOD virtual channel to be selected. If, instead, a VOD virtual channel is selected (block 1408), control proceeds to block 1412 at which a screenshot corresponding to the video signal output by the STB 616 is captured (e.g., using a framegrabber included in the OSDR 622). Then, at block 1416 the screenshot is analyzed (e.g., using an OCR engine included in the OSDR 622) to determine VOD program identification and other usage information, such as the specific VOD virtual channel selected, the VOD program title, the time at which the VOD program was displayed, any special operating condition (e.g., mute, pause, rewind, fast-forward, etc.), etc. Control then proceeds to block 1108.

Blocks 1108, 1112, 1116, 1120 and 1124 of process 1400 are substantially equivalent to the corresponding blocks in the process 1100 of FIG. 11. For brevity, these blocks are not re-described here. Rather, the interested reader is referred to the description of FIG. 11 for a detailed discussion of the above-identified blocks.

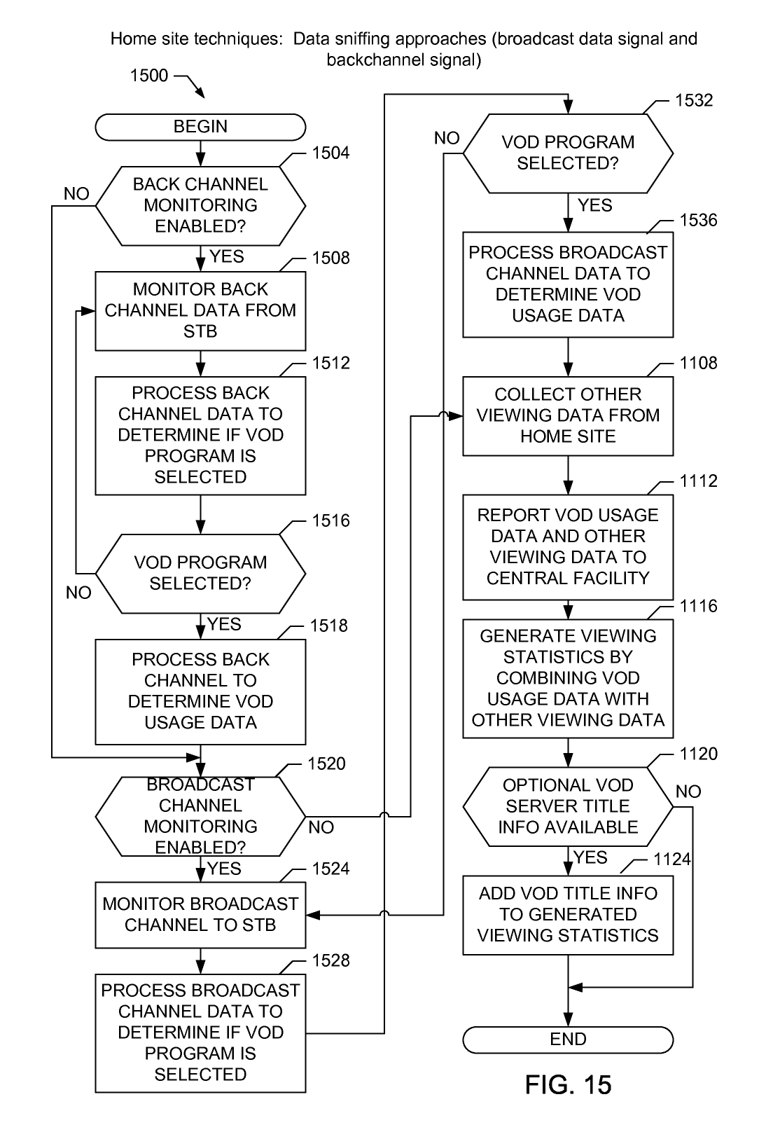

FIG. 15 illustrates an example process 1500 for monitoring VOD programming that may employ broadcast channel monitoring and/or back-channel monitoring of an STB. The example process 1500 may be used in VOD monitoring systems that include a sniffer attachment, such as the sniffer attachment 720 of FIG. 7. The example process 1500 begins at block 1504 wherein the sniffer attachment determines if back-channel monitoring is enabled. If back-channel processing is enabled (block 1504), control proceeds the back-channel data is monitored via, for example, the sniffer attachment 720 (block 1508). Then, at block 1512, the back-channel data is processed to determine if a VOD program has been selected by the STB 716. If a VOD program has been selected (block 1516), control proceeds to block 1518. At block 1518, the back-channel data is processed to determine VOD usage information (e.g., VOD program title, start time, etc.). Otherwise, if a VOD program is not selected (block 1516), control may return to block 1508, to wait for a VOD program to be selected.

If back-channel monitoring is not enabled (block 1504) or after the processing at block 1518 is completed, control proceeds to block 1520. At block 1520, the sniffer attachment determines if broadcast channel monitoring is enabled. If broadcast processing is enabled (block 1520), control proceeds to block 1524. At block 1524, the broadcast data is monitored via, for example, the sniffer attachment 720. Then, at block 1528, the broadcast channel data is processed to determine if a VOD program has been selected by the STB 716. If a VOD program is selected (block 1532), control proceeds to block 1536 at which the broadcast channel data is analyzed to determine VOD usage information (e.g., VOD program title, start time, etc.). Otherwise, if a VOD program has not been selected (block 1516), control may return to block 1524 to wait for a VOD program to be selected.

If broadcast channel monitoring is not enabled (block 1520) or after processing at block 1536 completes, control proceeds to block 1108. Blocks 1108, 1112, 1116, 1120 and 1124 of process 1500 are substantially equivalent to the corresponding blocks in the process 1100 of FIG. 11. For brevity, these blocks are not re-described here. Rather, the interested reader is referred to the description of FIG. 11 for a detailed discussion of the above-identified blocks.

C) Hybrid Techniques:

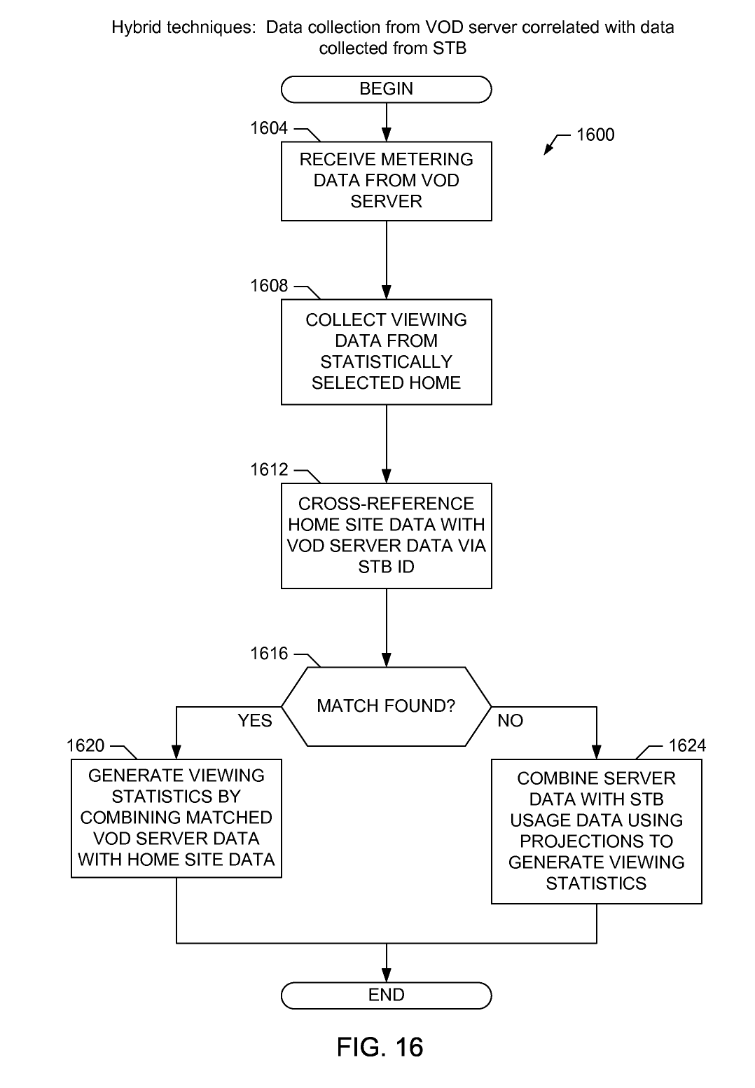

FIG. 16 illustrates an example process 1600 for monitoring VOD programming that may employ metered data from a VOD server and/or a statistically selected home. The example process 1600 may be used in VOD monitoring systems that support metering server interfaces and/or metering home interfaces, such as the metering server interface 324 and metering home interface 320 of FIG. 3. The example process 1600 begins at block 1604 when metering data is received from a VOD server (e.g., the VOD server 304) via the metering server interface 324. Such data may include the VOD program title, start time, end time, subscriber ordering information, etc. Next, at block 1608, viewing data and metering information is collected from the corresponding subscriber site. Such information may be extracted from the signal providing the VOD program content via the metering home interface 320. The VOD server metering data/information is then cross-referenced with the subscriber site metering data/information (e.g., via the STB ID of the STB 316) to associate VOD server data with the appropriate subscriber site data (block 1612). If a match is found (block 1616), control proceeds to block 1620 at which viewing statistics and crediting reports for the VOD programming content consumed at the selected subscriber site are generated. Otherwise, if a match is not found (block 1616), control may proceed to block 1624 at which statistical methods are used to combine the reported VOD server data with the reported subscriber side data (e.g., based on projecting the statistical characteristics of one of the VOD server data and the subscriber side data on the other of the subscriber side data and VOD server data).

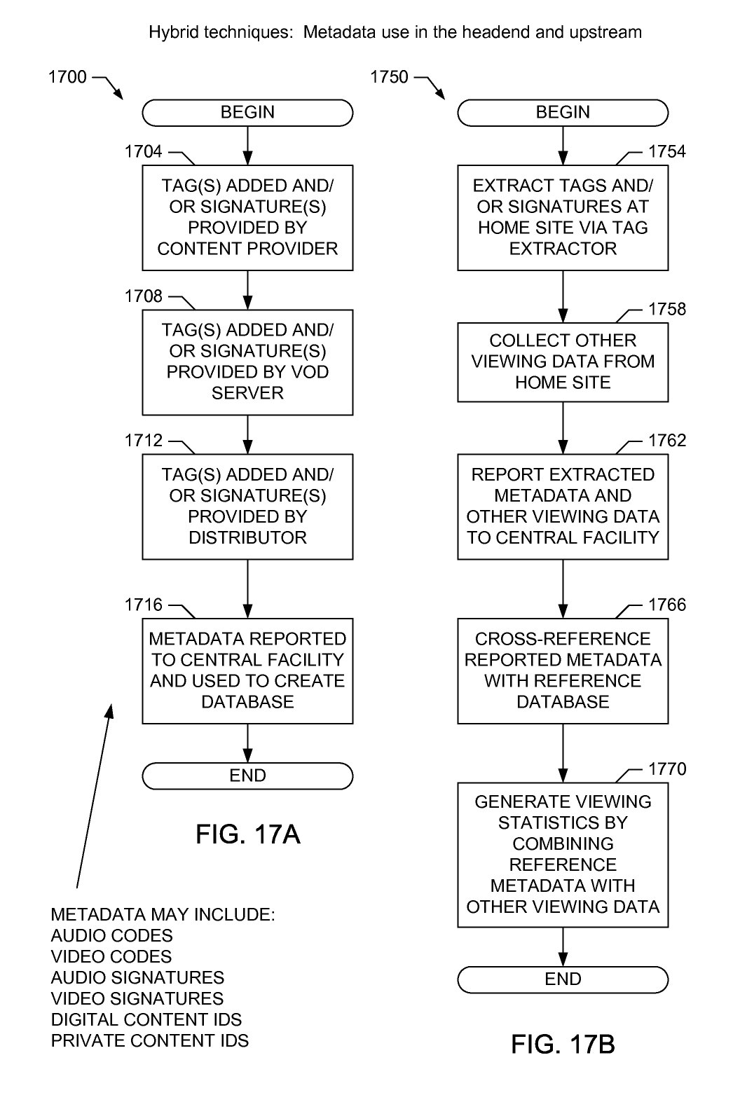

FIGS. 17A and 17B illustrate example processes 1700 and 1750 for monitoring VOD programming that may employ metadata to monitor viewing of VOD content. The example processes 1700 and 1750 may be used in VOD monitoring systems that support the tagging of content with metadata via one or more tagger units at provider and/or distribution sites, and a metadata tag extractor at a subscriber site, such as the tagger units 820, 824 and the metadata extractor 836 of FIG. 8. The example process 1700 of FIG. 17A may be used to collect reference metadata information corresponding to VOD programming content. Such metadata information may include audio/video ancillary codes, audio/video signatures, digital content identifiers (IDs) (e.g., such as Aux Data private data supported by the AC3 audio standard), private content IDs (such as those supported by the MPEG-2 and/or AC3 standards), etc. The example process 1750 of FIG. 17B may be used to monitor and credit VOD programming content based on metadata information.

The example process 1700 begins at block 1704 at which the VOD content provider may embed metadata information into and/or generate metadata corresponding to a VOD program via a tagger unit 820. Next, control proceeds to block 1708 at which the VOD server 804 may associate additional metadata information with the VOD program. Control then proceeds to block 1712 at which the distribution network 808 may associate additional metadata information with the VOD program via the tagger unit 824. Finally, control proceeds to block 1716 at which the various tagger units 820, 824 and/or the VOD server 804 may report the metadata information to the central facility 832 to create a database of reference metadata information for possible VOD programming content.

Turning to the example process 1750, the process 1750 begins at block 1754 at which metadata information is extracted and/or program signatures are generated, for example, via the metadata extractor 836 (possibly included in or coupled to a home unit, such as the home unit 124 of FIG. 1). Control then proceeds to block 1758 at which other viewing data such as that described above may be collected. Next, the extracted metadata and other collected viewing data are reported to the central facility 832 for processing (block 1762). Then, at block 1766, the reported metadata and other viewing data is cross-referenced with the reference metadata database created at block 1716. Finally, viewing statistics and/or crediting reports for the VOD programming content consumed at the selected subscriber site is generated by combining the reference metadata information with the other viewing data reported from the subscriber site.

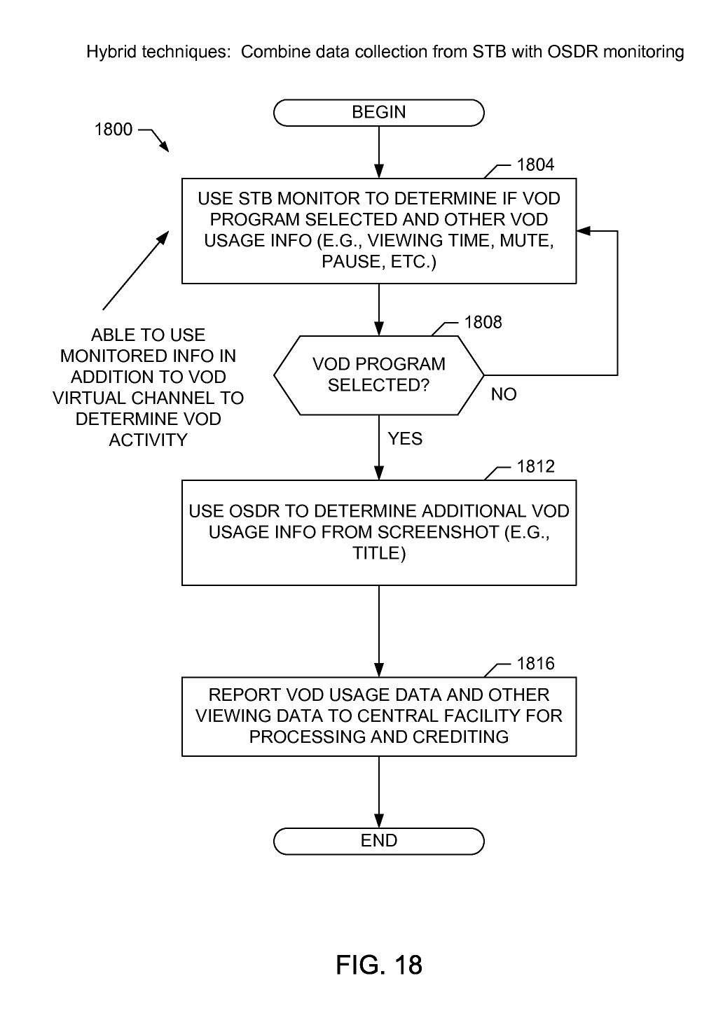

FIG. 18 illustrates an example process 1800 for monitoring VOD programming that may employ a combination of metered data from an STB (e.g., via the STB monitoring interface 520 of FIG. 5) and from an OSDR (such as the OSDR 622 of FIG. 6). The example process 1800 begins at block 1804 at which data/information collected via the STB monitoring interface 520 is used to determine whether a VOD program has been selected by the STB 516. The STB monitoring interface 520 may also be configured to provide additional metering information related to the viewing of VOD programs (e.g. viewing time, audio muting, pausing, etc.). If the process 1800 determines that a VOD program has not been selected (block 1808), control returns to block 1804. Control continues to loop through block 1804 and 1808 until a VOD program is selected by the STB 516. Otherwise, if a VOD program has been selected (block 1808), control proceeds to block 1812 at which the OSDR 620 is used to determine additional VOD usage information from one or more captured screenshots corresponding to the selected VOD program (e.g., program title information, etc.). By waiting for VOD programming to be selected before processing the captured screenshots, it may be possible to significantly reduce the processing complexity of the monitoring process 1800. Finally, the VOD usage data and any other collected viewing data/information are reported to the central facility 524 for processing and crediting (block 1816).

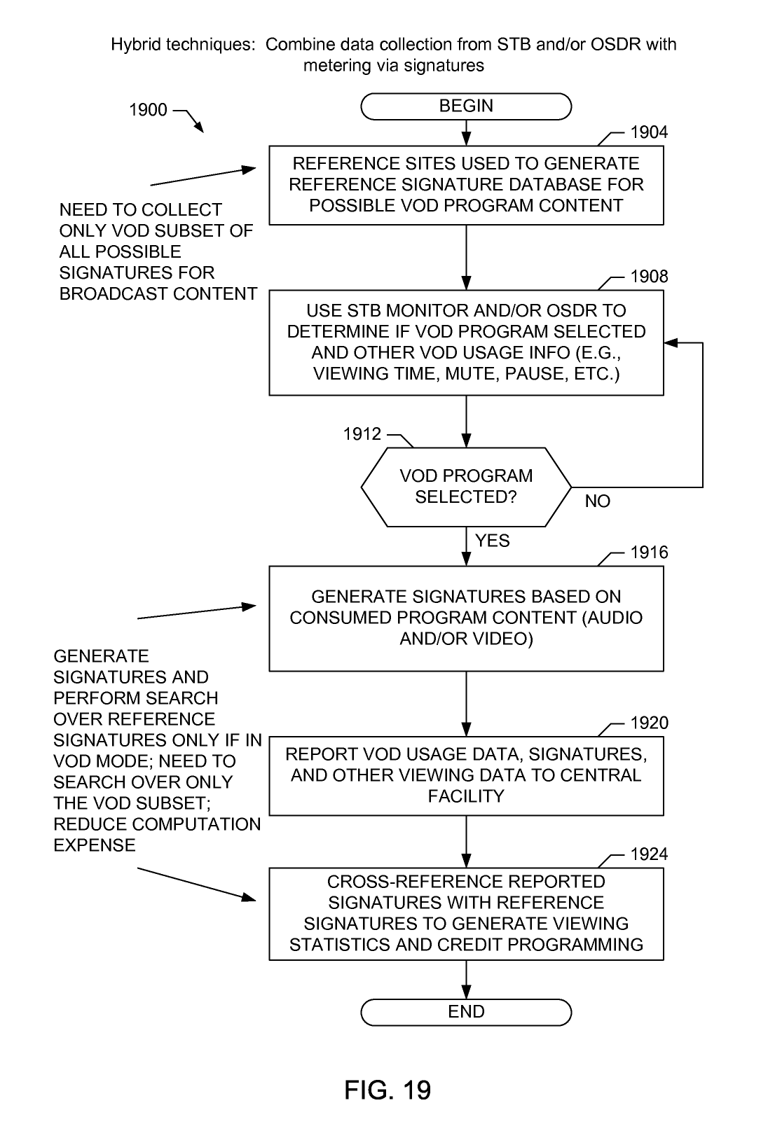

FIG. 19 illustrates an example process 1900 for monitoring VOD programming that may employ a combination of metered data from an STB (e.g., via the STB monitoring interface 520 of FIG. 5) and/or an OSDR (e.g., the OSDR 622 of FIG. 6) with generated content signatures to monitor viewing of VOD content. The example process 1900 begins at block 1904 when one or more reference sites are used to generate reference signatures corresponding to a set of possible VOD programming content (which may be a subset of all possible broadcast programming content). The reference signatures may be sent to a central facility (e.g., the central facility 524) to be included in a reference signature database. The monitoring of VOD programming consumption begins at block 1908 at which, for example, the STB monitoring interface 520 and/or the OSDR 622 (or any similar device) are used to determine whether a VOD program has been selected by the STB 516. At block 1908, additional viewing data may be collected as described above. If a VOD program has not been selected (block 1912), control returns to block 1908 to wait until a VOD program has been selected. Otherwise, if a VOD program has been selected (block 1912), control proceeds to block 1916.

At block 1916, one or more signatures are generated based on the VOD program content selected by the STB 516 using any technique known in the art. By waiting for VOD programming to be selected before generating the corresponding content signatures, it may be possible to significantly reduce the processing complexity of the monitoring process 1900. Control then proceeds to block 1920 at which the generated signatures and any other collected viewing data are reported to the central facility 524. Finally, the reported signatures are cross-referenced with the reference signature database to identify the consumed VOD programming content and to generate the corresponding crediting reports and/or viewing statistics.

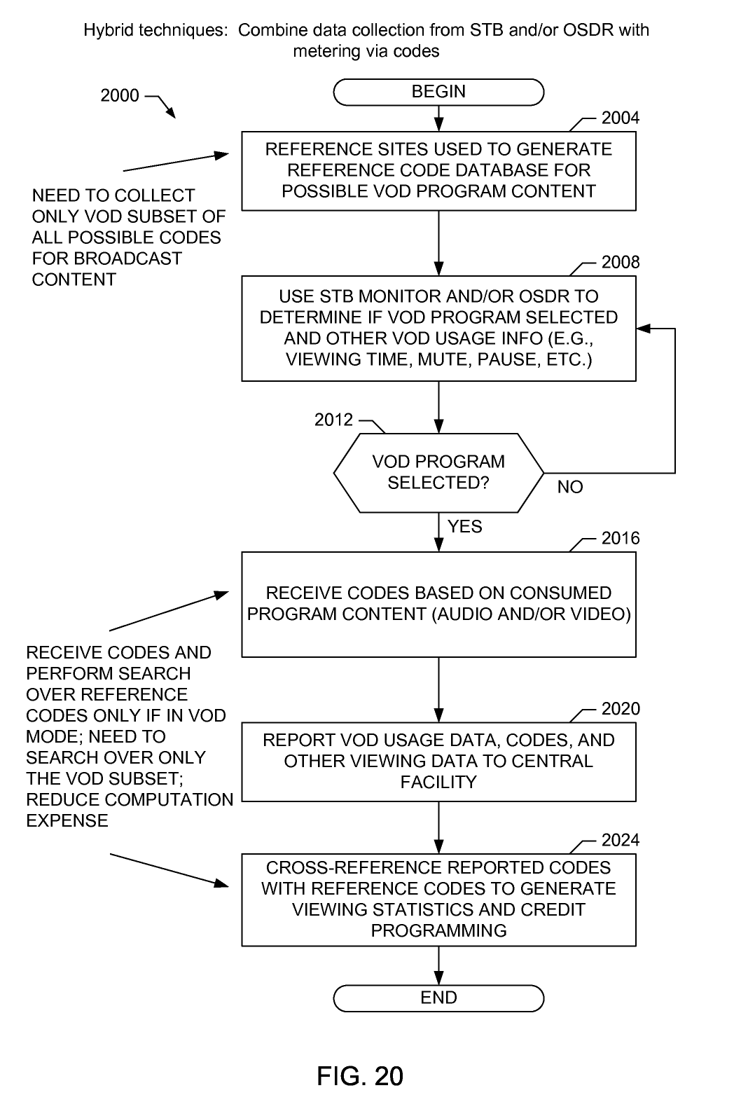

FIG. 20 illustrates an example process 2000 for monitoring VOD programming that may employ a combination of metered data from an STB (e.g., via the STB monitoring interface 520 of FIG. 5) and/or an OSDR (e.g., the OSDR 622 of FIG. 6) with ancillary codes to monitor viewing of VOD content. The processing performed by the example process 2000 is similar to that of the example process 1900 of FIG. 19, except that the process 1900 is based on the use of program signatures whereas the process 2000 is based on the use of program ancillary codes. Thus, for brevity, a detailed description of FIG. 20 is not provided herein. Instead, the interested reader if referred to the detailed description of FIG. 19 wherein the generating, processing, reporting and/or cross-referencing of program content signatures in blocks 1904, 1908, 1912, 1916, 1920 and 1924 is replaced in FIG. 20 by the generating, reporting and/or cross-referencing of program content codes in blocks 2004, 2008, 2012, 2016, 2020 and 2024.

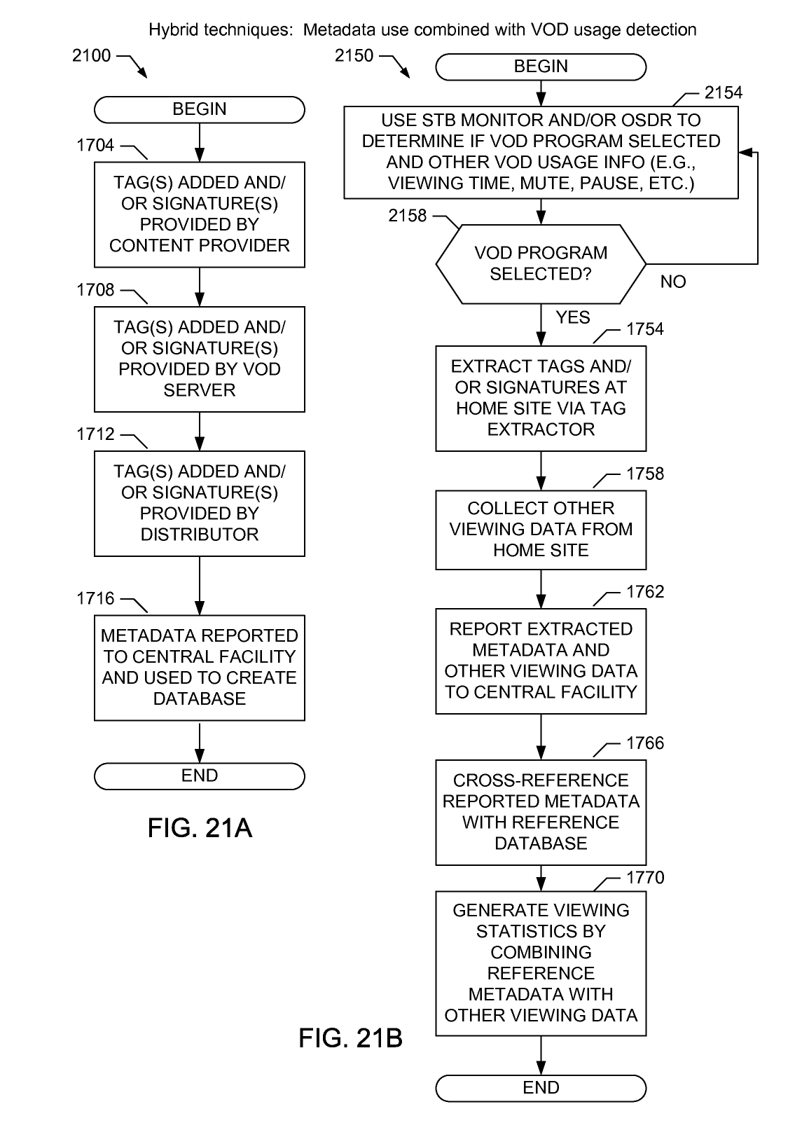

FIGS. 21A and 21B illustrate example processes 2100 and 2150 for monitoring VOD programming that may employ a combination of metadata and metered data from a subscriber site to monitor viewing of VOD content. The example process 2100 of FIG. 21A may be used to collect reference metadata information corresponding to VOD programming content. Such metadata information may include audio/video ancillary codes, audio/video signatures, digital content identifiers (IDs) (e.g., such as Aux Data private data supported by the AC3 audio standard), private content IDs (such as those supported by the MPEG-2 and/or AC3 standards), etc. The example process 2150 of FIG. 21B may be used to monitor and credit VOD programming content based on metadata information.

Blocks 1704, 1708, 1712 and 1716 of process 2100 are substantially identical to the corresponding blocks in the process 1700 of FIG. 17A. For brevity, these blocks are not re-described here. Rather, the interested reader is referred to the description of FIG. 17A for a detailed discussion of the above-identified blocks.

The example process 2150 begins at block 2154 at which, for example, an STB monitoring interface (such as the STB monitoring interface 520 of FIG. 5) and/or an OSDR (such as the OSDR 622 of FIG. 6), or any similar device, is used to determine whether a VOD program has been selected by a STB (such as the STB 516 of FIG. 5). At block 2158, additional viewing data may also be collected as described above. If a VOD program has not been selected (block 2158), control returns to block 2154 to wait until a VOD program has been selected. Otherwise, if a VOD program has been selected (block 2158), control proceeds to block 1754.

Blocks 1754, 1758, 1762, 1766 and 1770 of process 2150 are substantially identical to the corresponding blocks in the process 1750 of FIG. 17B. For brevity, these blocks are not re-described here. Rather, the interested reader is referred to the description of FIG. 17B for a detailed discussion of the above-identified blocks.

To better understand the benefits of collecting metering data from a VOD metering server interface (e.g., the metering server interface 324 of FIG. 3), an example viewing record 2400 generated by a local metering system, (e.g., the local metering system 100 of FIG. 1 or the metering home interface 320 of FIG. 3) is shown in FIG. 22. The viewing record is typically generated by a home unit, such as the home unit 124 of FIG. 1, and reported to a central facility, such as the central facility 328 of FIG. 3. The home unit 124 may send the stored viewing records to the central facility 328, for example, at periodic intervals (e.g., once a day), continuously, or at a-periodic intervals (e.g., whenever a predetermined event occurs). One having ordinary skill in the art will appreciate that a variety of viewing records substantially equivalent to the viewing record 2400 may be generated by the home unit 124. Such viewing records may include metering information in addition to and/or different from the example 2400 of FIG. 22, yet may still be used by the methods and/or apparatus described herein.

Turning to FIG. 22, the example viewing record 2400 includes a home unit ID 2404 to identify the home unit 124 that generated/reported the viewing record. The viewing record 2400 may also include a STB ID 2408 corresponding to the STB, such as the STB 316, that selected and/or presented the displayed broadcast or VOD programming content. The home unit ID 2404 and/or the STB ID 2408 may be used by the central facility 328 to cross-reference the reported viewing record 2400 with the corresponding VOD server data provided by the metering server interface 324.

The example viewing record also includes sets of channel data information 2412, 2414, 2416 corresponding to channels of the STB 316 selected by the user/subscriber. In the instant example, the home unit 124 is configured to poll the STB 316 at periodic intervals (e.g., once every 2.7 sec.) to determine the channel number selected by the STB 316. Additionally, the home unit 124 may be configured with a mapping table, for example, to map sets of channels into larger supersets of channels having similar content. For example, a set of broadcast channels used to carry pay-per-view programming may be grouped into a single superset representing all receivable pay-per-view content. Similarly, a set of broadcast channels used to carry VOD programming may be grouped and represented by a single superset used to indicate that VOD content was selected/output by the STB 316. As a result, the channel data 2412, 2414 that the home unit 124 includes in the example viewing record 2400 may comprise the channel number selected by the STB 316 and the timestamp at which the measurement was taken. Additionally or alternatively, the home unit 124 may include VOD data 2416 in the example viewing record 2400, with the VOD data 2416 including an entry indicating that any member of the superset of VOD channels was selected (represented by “VOD” in FIG. 22) and the timestamp at which the measurement was taken. Thus, as one having ordinary skill in the art will recognize, the example viewing record 2400 may be used to indicate that at least one of a superset of VOD channels was selected by the STB 316. However, the actual VOD channel selected and/or the actual VOD content selected/output by the STB 316 cannot be readily determined solely from the data included in the example viewing record 2400.

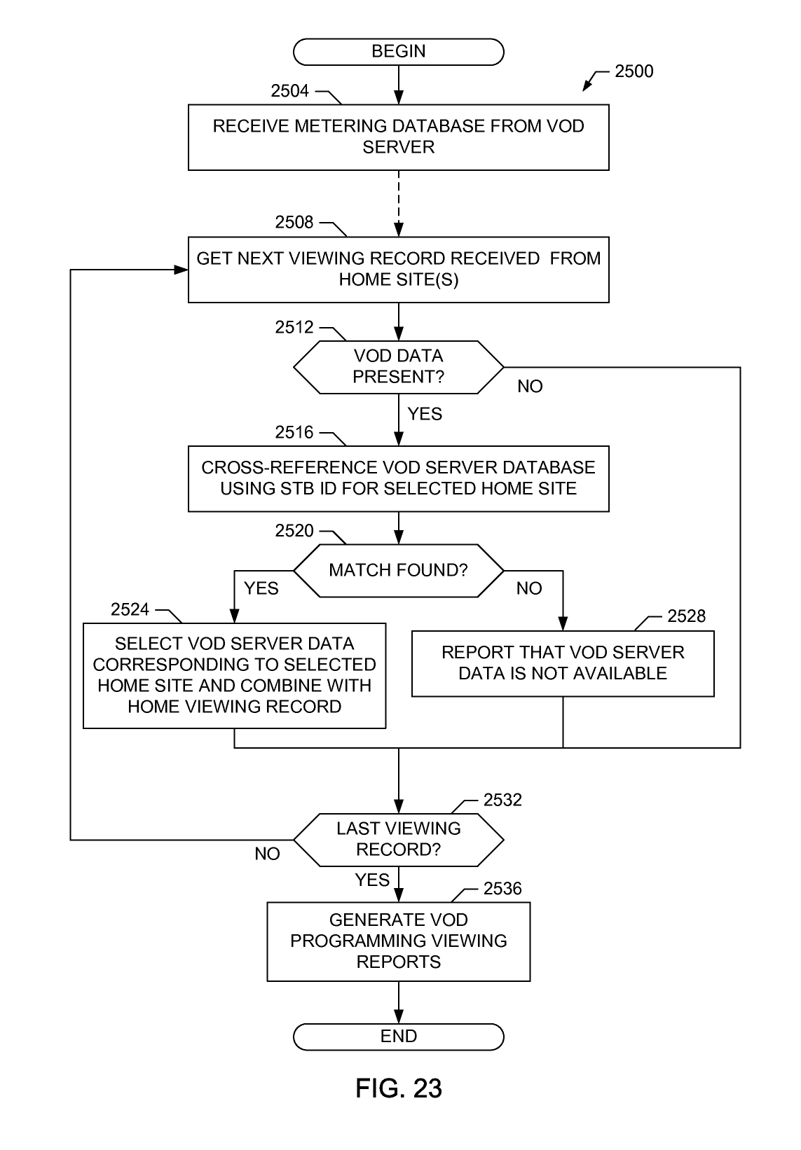

To determine the actual selected/displayed VOD content corresponding to a reported viewing record, such as the example viewing record 2400 of FIG. 22, a first example process 2500 to combine metering data from a VOD server with metering data reported from one or more statistically selected homes is illustrated in the flowchart of FIG. 23. Using FIG. 3 as a reference, to perform the example process 2500, a VOD metering server interface, such as the metering server interface 324, is configured to send a database of metering data for all households served by a VOD server, such as the VOD server 304, to a central facility, such as the central facility 328. The central facility 328 stores the data in this database and then cross-references such data based on, for example, the home unit ID 2404 and/or the STB ID 2408 provided in the example viewing record 2400. The central facility 328 may then augment the VOD data reported in the viewing record 2400 with the corresponding, specific VOD content information included in the VOD server metering database provided by the metering server interface 324.

Turning to FIG. 23, the example process 2500 begins at block 2504 at which the metering server interface 324 sends the VOD server metering database for all households served by the VOD server 304 to the central facility 328. The metering server interface 324 may be configured to send this database at predetermined times, for example, at periodic (e.g., daily) intervals. Alternatively, the metering server interface 324 may send the database upon the occurrence of one or more predetermined events (e.g., in response to a request from the central facility 328, when a predetermined amount of data is collected, etc.). At some time or times after processing at block 2504 completes, control proceeds to block 2508 at which the central facility 328 gets one or more viewing records (such as the example viewing record 2400 of FIG. 22) received from at least one metering home interface 320 (e.g., records generated and reported by a home unit, such as home unit 124, included in the metering home interface 320). Then at block 2512, the central facility 328 determines whether VOD data (e.g., VOD data 2416) is included in the reported viewing record 2400. If VOD data is present (block 2512), control proceeds to block 2516.

If VOD data 2416 is present in the received viewing record 2400 (block 2512), control proceeds to block 2516 at which the central facility 328 uses, for example, the reported home unit ID 2404 and/or the STB ID 2408 to cross-reference the VOD server metering database received at block 2504. If a match is found (block 2520), control proceeds to block 2524 at which the central facility 328 selects the corresponding entry or entries in the VOD server metering database and combines the selected VOD server metering data with the reported viewing record 2400 being processed (e.g., by replacing the generic VOD data 2416 with specific VOD server metering data included in the VOD server metering database). If, however, a cross-referencing match is not found (block 2520), control proceeds to block 2528 at which the central facility 328 indicates that VOD server metering information is not available for the viewing record 2400 being processed. Control then proceeds from either block 2524 or block 2528 to block 2532.

At block 2532, the central facility 328 determines whether the viewing record 2400 is the last viewing record to be processed. If the viewing record 2400 is not the last record to be processed (block 2532), control returns to block 2508 and blocks subsequent thereto at which the central facility 328 processes the next received viewing record. Conversely, if the viewing record 2400 is the last record to be processed (block 2532), control proceeds to block 2536 at which the central facility 328 generates ratings/metering reports for home sites that reported viewing records 2400 corresponding to the presentation of VOD programming content. The example process 2500 then ends.

One having ordinary skill in the art will appreciate that processing represented by blocks 2508 through 2536 may be executed, for example, on an event-driven basis corresponding to the receipt of one or more viewing records from one or more households. Such processing may also be iterated multiple times, for example, one iteration for each received viewing record, one iteration for each instance of reported VOD data in a received viewing record, etc.

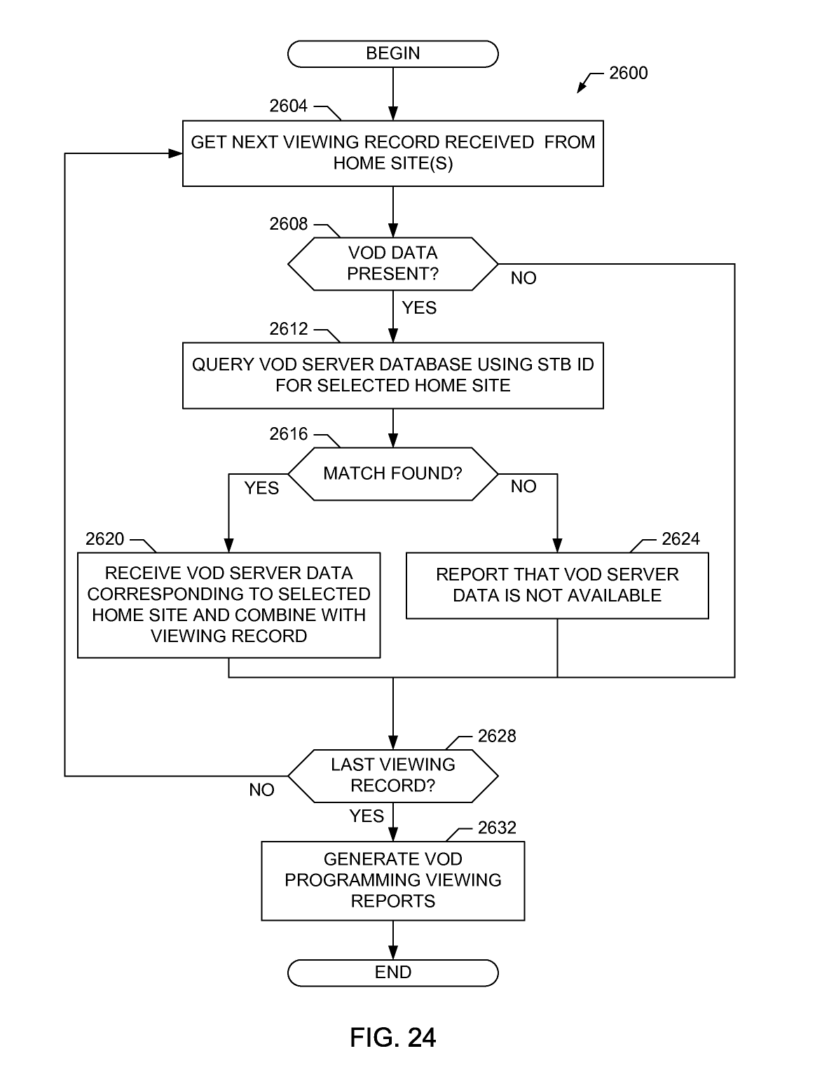

FIG. 24 is a flowchart of a second example process 2600 to monitor VOD programming that may combine metering data from a VOD server with metering data from one or more statistically selected homes. Again using FIG. 3 as a reference, for the example process 2600, a central facility, such as the central facility 328, is configured to receive one or more viewing records, such as the example viewing record 2400 of FIG. 22, from one or more metering home interfaces, such as the metering home interface 320. The central facility 328 then queries at least one metering server interface, such as the metering server interface 324, to provide VOD content metering information corresponding to the household represented by the received viewing record 2400 (e.g., by querying a particular metering server interface 324 or a subset of such interfaces corresponding to the household identified by the home unit ID 2404 and/or the STB ID 2408 provided in the example viewing record 2400, or querying all available metering server interfaces 324 to provide data corresponding to the home unit ID 2404 and/or the STB ID 2408). The metering server interface 324 returns such information based on data obtained from a monitored VOD server, such as the VOD server 304. The central facility 328 then combines the queried VOD server metering information with the reported metering information in the viewing record 2400 to generate the appropriate ratings/metering report(s).

Turning to FIG. 24, processing begins at block 2604 at which the central facility 328 gets one or more viewing records (such as the example viewing record 2400 of FIG. 22) received from at least one metering home interface 320 (e.g., generated and reported by a home unit, such as home unit 124, included in the metering home interface 320). Then at block 2608, the central facility 328 determines whether VOD data (e.g., VOD data 2416) is included in the reported viewing record 2400. If VOD data is present (block 2608) control proceeds to block 2612 and blocks subsequent thereto.

If VOD data 2416 is present in the received viewing record 2400 (block 2608), control proceeds to block 2612 at which the central facility 328 uses, for example, the reported home unit ID 2404 and/or the STB ID 2408 to query one or more metering server interfaces 324 corresponding to one or more VOD servers 304. In the instant example, the metering server interface 324 and/or a combination of the metering server interface 324 and the VOD server 304 maintains a VOD server metering database corresponding to all households served by the VOD server 304. If a match is found (block 2616), control proceeds to block 2620 at which the metering server interface 324 returns the corresponding entry or entries in the VOD server metering database and the central facility 328 combines such VOD server metering data with the reported viewing record 2400 being processed (e.g., by replacing the generic VOD data 2416 with specific VOD server metering data returned by the metering server interface 324). If, however, a cross-referencing match is not found (block 2616), control proceeds to block 2624 at which the central facility 328 indicates that VOD server metering information is not available for the viewing record 2400 being processed. Control then proceeds from either block 2620 or block 2624 to block 2628.

At block 2628, the central facility 328 determines whether the viewing record 2400 is the last viewing record to be processed. If the viewing record 2400 is not the last record to be processed (block 2628), control returns to block 2604 and blocks subsequent thereto at which the central facility 328 processes the next received viewing record. Conversely, if the viewing record 2400 is the last record to be processed (block 2628), control proceeds to block 2632 at which the central facility 328 generates ratings/metering reports for home sites that reported viewing records 2400 corresponding to the presentation of VOD programming content. The example process 2600 then ends.

One having ordinary skill in the art will appreciate that the example process 2600 may be executed, for example, on an event-driven basis corresponding to the receipt of one or more viewing records from one or more households. Such processing may also be iterated multiple times, for example, one iteration for each receiver viewing record, one iteration for each instance of reported VOD data in a received viewing record, etc.

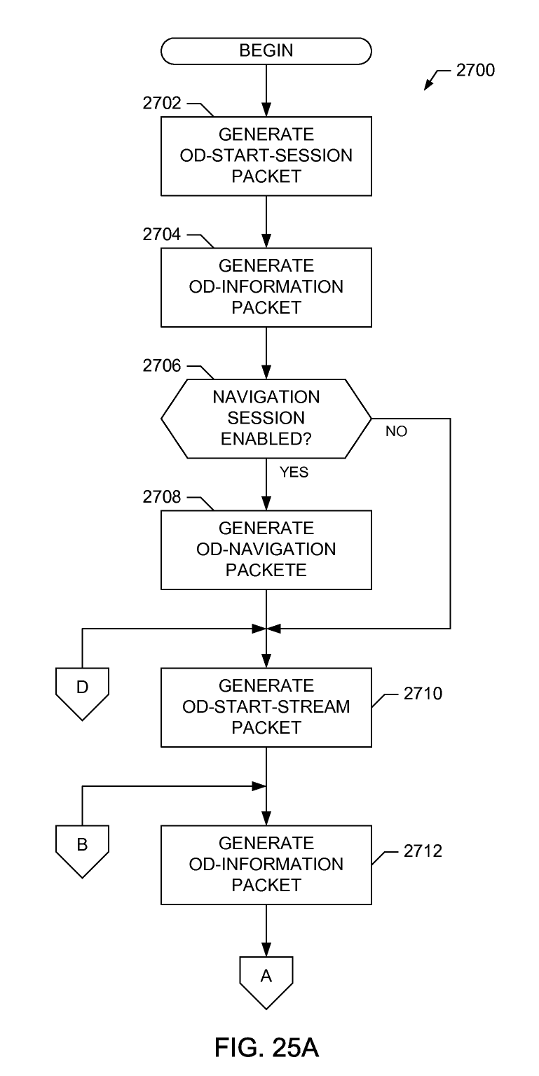

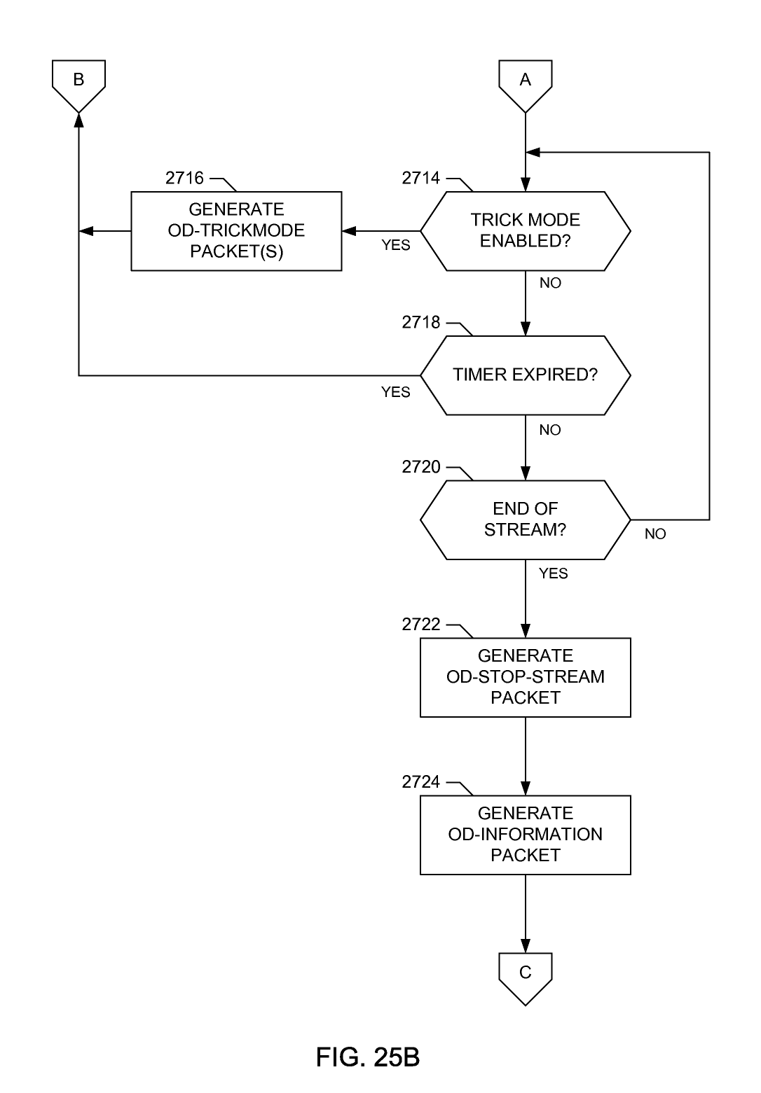

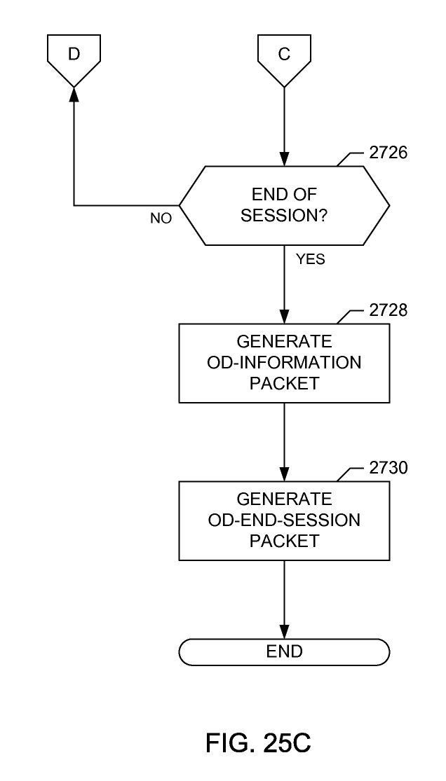

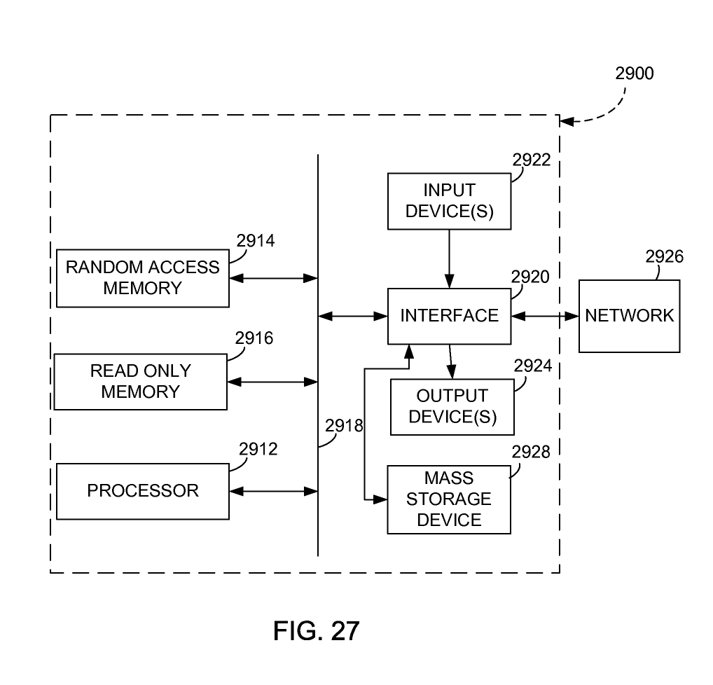

A flowchart representative of example machine readable instructions for implementing at least portions of the VOD server 304 and/or the metering server interface 324 of FIG. 3 is shown in FIGS. 25A-25C. In this example, the process represented by the flowchart may be implemented by a set of machine readable instructions that may comprise one or more programs for execution by a processor, such as the processor 2912 shown in the example computer 2900 discussed below in connection with FIG. 27. The one or more programs may be embodied in software stored on a tangible medium such as a CD-ROM, a floppy disk, a hard drive, a DVD, or a memory associated with the processor 2912, but persons of ordinary skill in the art will readily appreciate that the entire program and/or portions thereof could alternatively be executed by a device other than the processor 2912 and/or embodied in firmware or dedicated hardware in a well-known manner. For example, any or all of the VOD server 304 and the metering server interface 324 could be implemented by any combination of software, hardware, and/or firmware. Further, although the example programs are described with reference to the flowchart illustrated in FIGS. 25A-25C, persons of ordinary skill in the art will readily appreciate that many other methods of implementing the example methods and apparatus described herein may alternatively be used. For example, with reference to the flowchart illustrated in FIGS. 25A-25C, the order of execution of the blocks may be changed, and/or some of the blocks described may be changed, eliminated, combined and/or subdivided into multiple blocks.

An example program 2700 to implement at least portions of the VOD server 304 and/or the metering server interface 324 of FIG. 3 is shown in FIGS. 25A-25C. The example program 2700 may be used to create the VOD server database (or contents thereof) provided as input to the example processes 2500 and 2600 of FIGS. 23 and 24, respectively. The program 2700 may be executed in response to VOD service requests (e.g., VOD content selections) sent by, for example, the STB 316 to the VOD server 304. The example program 2700 begins at block 2702 of FIG. 25A at which the VOD server 304 determines that the STB 316 has selected a VOD channel for display. In response, the VOD server 304 generates an OD-START-SESSION information packet at block 2702 to indicate that an on-demand (e.g., VOD) session was initiated corresponding to the selection of the VOD channel. The OD-START_SESSION packet marks the beginning of a VOD session and may contain descriptive information such as the STB ID of the STB 316, a unique session identifier to identify the particular VOD session established between the VOD server 304 and the STB 316, and a timestamp to indicate when the VOD session was initiated. Control then proceeds to block 2704 at which the VOD server 304 generates an OD-INFORMATION information packet to provide additional descriptive information regarding the current VOD session.

An OD-INFORMATION packet may include, for example, any or all of the following data: the STB ID of the STB 316, the session ID, a timestamp, an overall bitrate for the VOD session, a description of the VOD session connection type (e.g., TCP, UDP, etc.), one or more counters indicating any errors (e.g., stream errors, communications errors, system errors, etc.) that may have occurred since initiation of the VOD session, major and/or minor channel numbers corresponding to the VOD channel selected by the STB 316, etc. OD-INFORMATION packets may be generated at various times throughout the duration of a VOD session, for example, at session initiation (block 2704), at session termination (block 2728 described below) and at periodic (e.g., five minute) intervals while the VOD session is active (block 2712 described below). Control then proceeds to block 2706.

Upon selection of a VOD channel, the VOD server 304 may cause a VOD navigation menu to be displayed via the STB 316. Additionally or alternatively, an audience member may cause a navigation menu to be displayed, for example, by pressing an appropriate input key on a remote control device, such as the remote control device 160 of FIG. 1. Thus, at block 2706 the VOD server 304 determines whether a navigation session has been initiated. If a navigation session has been enabled (block 2706), control proceeds to block 2708 at which the VOD server 304 generates an OD-NAVIGATION packet.

An OD-NAVIGATION packet may include, for example, any or all of the following data: the STB ID of the STB 316, the session ID, a timestamp, a navigation code to indicate the usage of the navigation menu (e.g., an up arrow button press, a down arrow button press, a page up button press, a page down button press, a program information (info) button press, a select/OK button press, etc.), etc. Thus, multiple OD-NAVIGATION packets may be generated during an active navigation session as the audience member navigates through the navigation menu. Upon termination of the navigation session or if a navigation session was not initiated, control proceeds to block 2710.

At block 2710, the VOD server 304 generates an OD-START_STREAM information packet corresponding to the VOD content stream sent by the VOD server 304 for display via the STB 316. Multiple VOD content streams may be activated throughout the duration of a VOD session. For example, after a VOD session is initiated (e.g., through selection of a VOD channel) and a navigation session, if applicable, terminates, the VOD server 304 may initiate a VOD content stream that carries a movie trailer or a targeted advertisement. The OD-START_STREAM packet of the illustrated example includes descriptive data corresponding to the active VOD content stream, such as any or all of the following: the STB ID of the STB 316, the session ID, a timestamp, a stream ID to uniquely identify the active VOD content stream, a program/asset ID to uniquely identify the content (e.g., movie trailer, advertisement, VOD program, etc.) being carried by the VOD content stream, a program/asset title, a program/asset type identifier (e.g., pay-per-view movie, free movie on-demand, advertisement, long advertisement, targeted advertisement, etc.), a station/studio ID to uniquely identify the originator of the VOD content, a station/studio name, a genre identifier to indicate the genre to which the VOD content belongs (e.g., talk show, drama, sporting event, etc.), an MPA rating for the VOD content carried by the active stream, etc. After the OD-START_STREAM packet is generated, control proceeds to block 2712 at which the VOD server 304 generates another OD-INFORMATION packet corresponding to the active VOD content stream. Control then proceeds to block 2714 of FIG. 25B.

At block 2714, the VOD server 304 determines whether an audience member has activated a trick-mode of operation via the STB 316. The VOD server may support trick-mode capability to allow the viewer to alter the linear nature of the VOD content stream. Trick-modes may include fast-forward, rewind, pause, play, etc. For example, an audience member may pause, via the pause trick-mode, a displayed VOD program to place a telephone call. The audience member may then resume the VOD program after completing the telephone call via the play trick-mode. Thus, multiple trick-modes may occur during the duration of an active VOD content stream. If the VOD server 304 determines that a trick-mode has been enabled (block 2714), control proceeds to block 2716 at which the VOD server 304 generates an OD_TRICKMODE information packet corresponding to the enabled trick-mode.

An OD-TRICKMODE packet may include, for example, any or all of the following data: the STB ID of the STB 316, the session ID, a timestamp, the stream ID, a trick indicator to indicate the type of trick-mode that was enabled (e.g., fast-forward, rewind, pause, play, etc.), a trick-mode offset timestamp that represents an offset between the time at which the VOD content stream was initiated and the time at which the trick-mode was enabled, etc. After the OD-TRICKMODE is generated, control returns to block 2712 of FIG. 25A at which the VOD server 304 generates another OD-INFORMATION packet corresponding to the enabled trick-mode. Control then proceeds to block 2714 of FIG. 25B and blocks subsequent thereto at which the VOD server 304 determines whether another trick-mode has been enabled.

If at block 2714 the VOD server 304 determines that a trick-mode was not enabled, control proceeds to block 2718 at which the VOD server determines whether a periodic information reporting timer has expired. If such a timer has expired (block 2718), control returns to block 2712 of FIG. 25A at which the VOD server 304 generates another OD-INFORMATION packet corresponding to the active VOD content stream. Control then proceeds again to block 2714 at which the VOD server 304 checks whether a trick-mode has been enabled.

If at block 2718 the VOD server 304 determines that the timer has not expired, control proceeds to block 2720 at which the VOD server 304 determines whether the current VOD content stream has terminated (e.g., a targeted advertisement has completed prior to the start of a VOD program). If at block 2720 the VOD server 304 determines that the VOD content stream has not terminated (i.e., is still active), control returns to block 2714 of FIG. 25B at which the VOD server 304 again checks whether a trick-mode has been enabled.

If at block 2720 the VOD server determines that the current VOD content stream has terminated, control proceeds to block 2722 at which the VOD server generates an OD-STOP STREAM information packet corresponding to the terminated VOD content stream. The OD-STOP STREAM packet may include, for example, information such as the STB ID of the STB 316, the session ID, a timestamp, the stream ID, etc. Control then proceeds to block 724 at which the VOD server 304 generates another OD-INFORMATION packet corresponding to the terminated VOD content stream. Control then proceeds to block 2726 of FIG. 25C at which the VOD server 304 determines whether the current VOD session has terminated. If the VOD session has not terminated (i.e., is still active), control returns to block 2710 of FIG. 25A at which the VOD server 304 generates another OD-START_SESSION packet corresponding to the next initiated VOD content stream (e.g., a VOD program starting after the completion of a previous movie trailer or targeted advertisement).

If, however, at block 2726 the VOD server 304 determines that the current VOD session has terminated, control proceeds to block 2728 at which the VOD server generates another OD-INFORMATION packet corresponding to the terminated VOD session. Control then proceeds to block 2730 at which the VOD server 304 generates an OD-END-SESSION packet corresponding to the terminated VOD session. The OD-END-SESSION packet may include, for example, information such as the STB ID of the STB 316, the session ID, a timestamp, etc. After generation of the OD-END-SESSION packet, the example program 2700 of FIGS. 25A-25C ends.

One having ordinary skill in the art will appreciate that the execution order of at least some of the blocks in the example program 2700 of FIGS. 25A-25C may be varied as needed to support generation of VOD server database information in addition to that described above. For example, to support generation of OD-NAVIGATION packets in cases in which the viewer activates a navigation menu during presentation of a VOD program, blocks 2706 and 2708 could also be executed in an interrupt handler triggered by the activation of the navigation menu. One having ordinary skill in the art will also appreciate that, while the example program 2700 was described as being executed via the VOD server 304, other substantially equivalent implementations may be employed. For example, the example program 2700 could be executed via the metering server interface 324 or a combination of the VOD server 304 and the metering server interface 324.

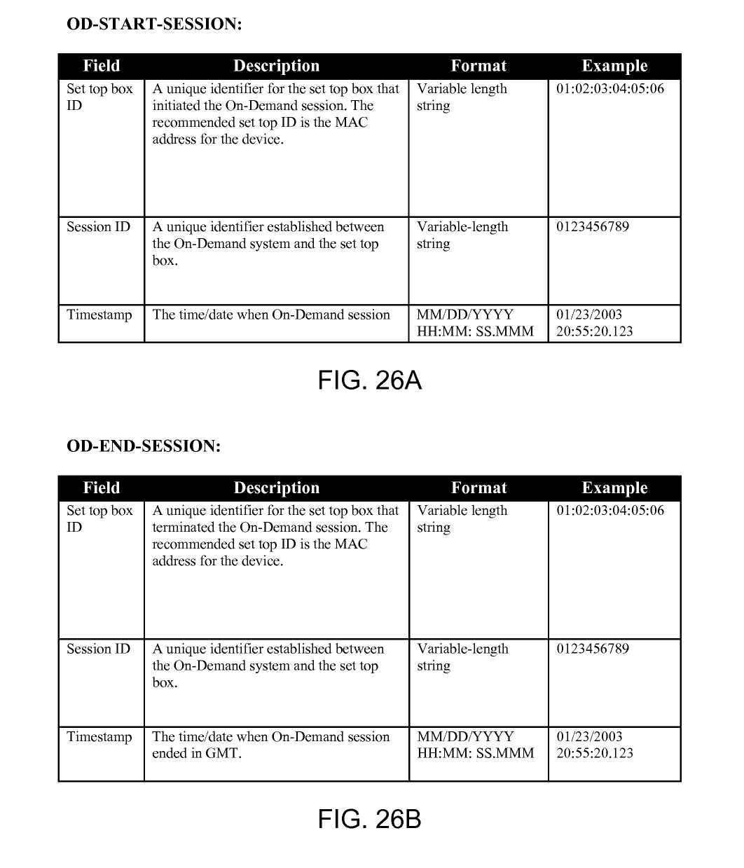

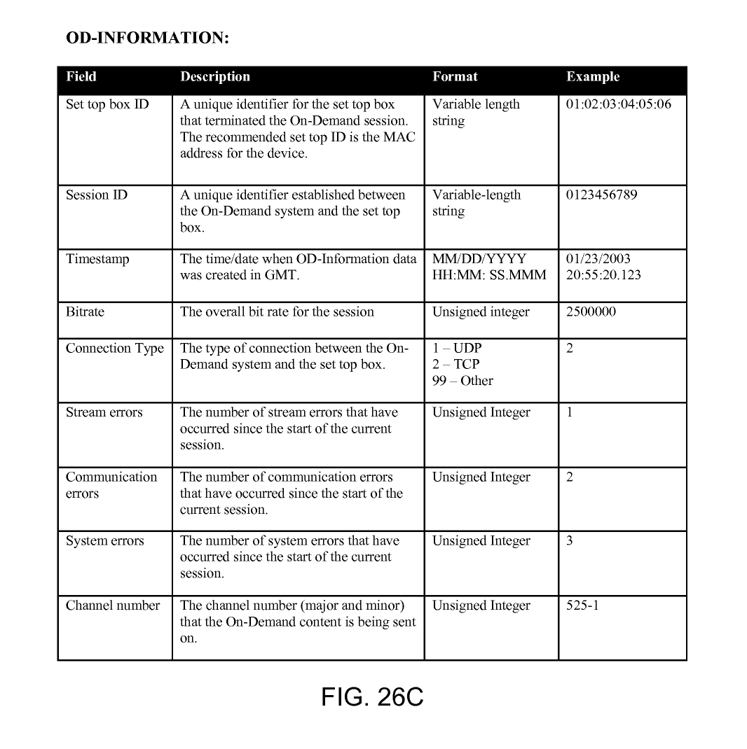

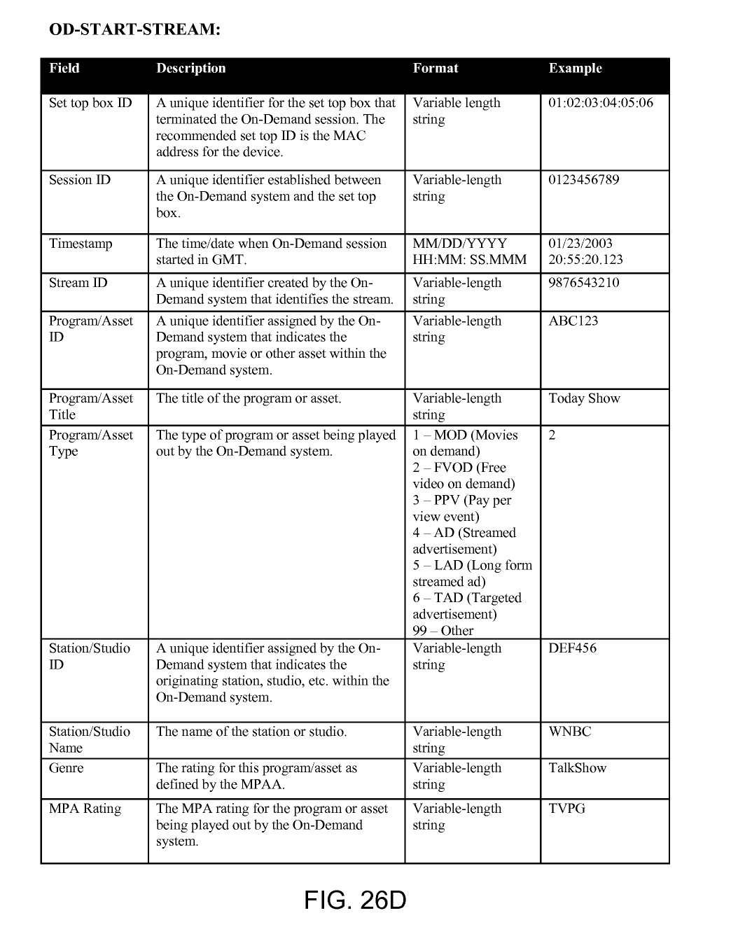

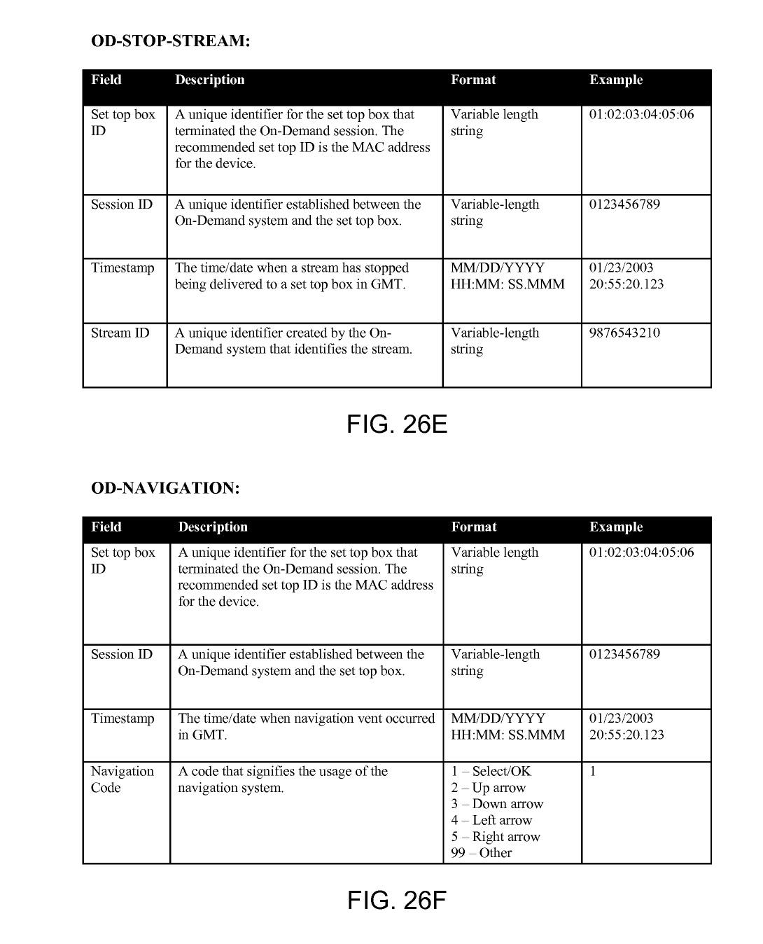

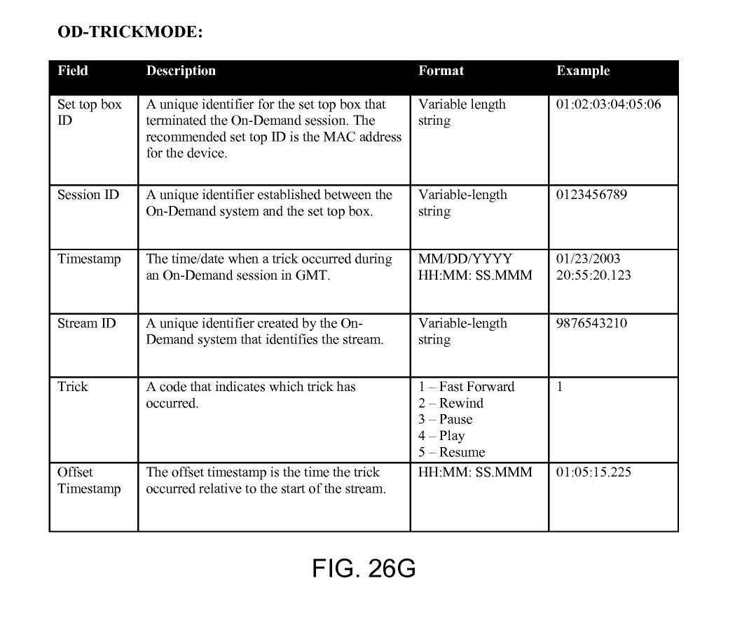

Example VOD server information packets that may be generated by the example program 2700 of FIGS. 25A-25C are shown in FIGS. 26A-26G. As described above, these information packets may be used to create the VOD server database (or contents thereof) provided as input to the example processes 2500 and 2600 of FIGS. 23 and 24, respectively. The example information packets illustrated in FIGS. 26A-26G include an OD-START-SESSION packet, an OD-END-SESSION packet, an OD-INFORMATION packet, an OD-START-STREAM packet, an OD-STOP-STREAM packet, an OD-NAVIGATION packet and an OD-TRICKMODE packet.

Example OD-START-SESSION and OD-END-SESSION information packets are shown in FIGS. 26A and 26B, respectively. An OD-START-SESSION packet may be generated, for example, at block 2702 of the example program 2700 of FIG. 25A-25C to indicate the start of a VOD session. Similarly, the program 2700 may generate an OD-END-SESSION packet at block 2730 to indicate the end of a VOD session. Both of the example OD-START-SESSION and OD-END-SESSION packets have similar information fields, including an STB ID field, a session ID field and a timestamp field. As shown in FIGS. 26A and 26B, the STB ID is a unique identifier that may correspond, for example, to the MAC (medium-access-control) address of the STB that initiated the VOD session (e.g., STB 316 of FIG. 3). The session ID is a unique identifier corresponding to the VOD session initiated between an STB and a VOD server (e.g., the STB 316 and the VOD server 304). The timestamp includes the date and time at which the respective OD-START-SESSION or OD-END-SESSION packet was generated.

An example OD-INFORMATION packet is shown in FIG. 26C. An OD-INFORMATION packet may be generated, for example, at various blocks of the example program 2700 of FIG. 25A-25C to provide descriptive information regarding a variety of events. For example, OD-INFORMATION packets may be generated at block 2704 to further describe an initiated VOD session, at block 2712 to further describe an initiated VOD content stream and/or VOD content stream modified via a trick-mode, at block 2724 to further describe a terminated VOD content stream and/or at block 2728 to further describe a terminated VOD session. The example OD-INFORMATION packet of FIG. 26C has multiple information fields, including an STB ID field, a session ID field, a timestamp field, a bitrate field, a connection type field, a stream errors field, a communication errors field, a system errors field and a channel number field. The format and contents of the STB ID field, the session ID field and the timestamp field are similar to that of the OD-START-SESSION and OD-END-SESSION packets described above and, as such, are not described further herein. The bitrate field indicates the aggregate bit rate of the active VOD session. The connection type field includes an identifier corresponding to the specific type of data connection that carries the active VOD session (e.g., TCP, UDP, etc.). The stream errors, communication errors and system errors fields include counter values corresponding to the number of stream errors, communication errors and system errors, respectively, that have occurred since initiation of the active VOD session. The channel number field includes an identifier corresponding to the selected VOD channel (e.g., major and minor channel) used to send the selected VOD content from a VOD server to an STB (e.g., the VOD server 304 and the STB 316 of FIG. 3).

Example OD-START-STREAM and OD-STOP-STREAM information packets are shown in FIGS. 26D and 26E, respectively. An OD-START-STREAM packet may be generated, for example, at block 2710 of the example program 700 of FIG. 26A-26C to indicate the start of a VOD content stream. Similarly, the program 2700 may generate an OD-STOP-STREAM packet at block 2722 to indicate the termination of a VOD stream. Both of the example OD-START-STREAM and OD-STOP-STREAM packets have similar information fields, including an STB ID field, a session ID field, a timestamp field and a stream ID field. The format and contents of the STB ID field, the session ID field and the timestamp field are similar to that of the OD-START-SESSION and OD-END-SESSION packets described above and, as such, are not described further herein. The stream ID field is a unique identifier corresponding to the current VOD content stream being used to carry the VOD content for the active VOD session.

The example OD-START-STREAM information packet of FIG. 26D also includes additional fields, such as a program/asset ID field, a program/asset title field, a program/asset type field, a station/studio ID field, a station/studio name field, a genre field and an MPA rating field. The program/asset ID field includes a unique identifier corresponding to the content (e.g., movie trailer, advertisement, VOD program, etc.) being carried by the VOD content stream. The program/asset title field includes the name of current VOD program/asset. The program/asset type field includes an identifier corresponding to the type of the current VOD program/asset (e.g., pay-per-view movie, free movie on-demand, advertisement, long advertisement, targeted advertisement, etc.). The station/studio ID field includes a unique identifier corresponding to the originator of the current VOD program/asset. The station/studio name field includes the name of the originator of the current VOD program/asset. The genre field includes an identifier to indicate the genre to which the current VOD content belongs (e.g., talk show, drama, sporting event, etc.). The MPA rating field includes the MPA rating assigned to the VOD content carried by the active stream.

An example OD-NAVIGATION packet is shown in FIG. 26F. An OD-NAVIGATION packet may be generated, for example, at block 2708 of the example program 2700 of FIG. 25A-25C to provide information corresponding to the activation of a VOD navigation menu. The example OD-NAVIGATION packet has information fields, including an STB ID field, a session ID field, a timestamp field and a navigation code field. The format and contents of the STB ID field, the session ID field and the timestamp field are similar to that of the OD-START-SESSION and OD-END-SESSION packets described above and, as such, are not described further herein. The navigation code field includes an identifier corresponding to the usage of the navigation menu (e.g., an up arrow button press, a down arrow button press, a page up button press, a page down button press, a program information (info) button press, a select/OK button press, etc.).

An example OD-TRICKMODE packet is shown in FIG. 26G. An OD-TRICKMODE packet may be generated, for example, at block 2716 of the example program 2700 of FIG. 25A-25C to provide information corresponding to initiation of a trick-mode of operation during an active VOD content stream. The example OD-TRICKMODE packet has multiple information fields, including an STB ID field, a session ID field, a timestamp field, a stream ID field, a trick field and an offset timestamp field. The format and contents of the STB ID field, the session ID field, the timestamp field and the stream ID field are similar to that of the OD-START-STREAM and OD-STOP-STREAM packets described above and, as such, are not described further herein. The trick field includes an identifier corresponding to the trick-mode activated by the audience member (e.g., fast-forward, rewind, pause, play, etc.). The offset timestamp field represents an offset between the time at which the VOD content stream was initiated and the time at which the trick-mode was activated.

FIG. 27 is a block diagram of an example computer 2900 capable of implementing the apparatus and methods disclosed herein. The computer 2900 can be, for example, a server, a personal computer, a personal digital assistant (PDA), an Internet appliance, or any other type of computing device.

The system 2900 of the instant example includes a processor 2912. For example, the processor 2912 can be implemented by one or more Intel® microprocessors from the Pentium® family, the Itanium® family or the XScale® family. Of course, other processors from other families are also appropriate. One or more processors such as processor 2912 may be used to implement any or all of, for example, the home unit 124 and/or the STB 108 (or portions thereof) of FIG. 1, the central facility processor 224 (or portions thereof) of FIG. 2, and/or the VOD server 304 and/or the metering server interface 324 of FIG. 3. A processor such as processor 2912 may also be used to implement the example program 2700 of FIGS. 25A-25C.

The processor 2912 is in communication with a main memory including a volatile memory 2914 and a non-volatile memory 2916 via a bus 2918. The volatile memory 2914 may be implemented by Static Random Access Memory (SRAM), Synchronous Dynamic Random Access Memory (SDRAM), Dynamic Random Access Memory (DRAM), RAMBUS Dynamic Random Access Memory (RDRAM) and/or any other type of random access memory device. The non-volatile memory 2916 may be implemented by flash memory and/or any other desired type of memory device. Access to the main memory 2914, 2916 is typically controlled by a memory controller (not shown) in a conventional manner.

The computer 2900 also includes a conventional interface circuit 2920. The interface circuit 2920 may be implemented by any type of well-known interface standard, such as an Ethernet interface, a universal serial bus (USB), and/or a third generation input/output (3GIO) interface.

One or more input devices 2922 are connected to the interface circuit 2920. The input device(s) 2922 permit a user to enter data and commands into the processor 2912. The input device(s) can be implemented by, for example, a keyboard, a mouse, a touchscreen, a track-pad, a trackball, an isopoint and/or a voice recognition system.

One or more output devices 2924 are also connected to the interface circuit 2920. The output devices 2924 can be implemented, for example, by display devices (e.g., a liquid crystal display, a cathode ray tube display (CRT)), by a printer and/or by speakers. The interface circuit 2920, thus, typically includes a graphics driver card.

The interface circuit 2920 also includes a communication device such as a modem or network interface card to facilitate exchange of data with external computers via a network 2926 (e.g., an Ethernet connection, a digital subscriber line (DSL), a telephone line, coaxial cable, a cellular telephone system, etc.). The interface circuit 2920 and the network 2926 may implement the connection 140 of FIG. 1.

The computer 2900 also includes one or more mass storage devices 2928 for storing software and data. Examples of such mass storage devices 2928 include floppy disk drives, hard drive disks, compact disk (CD) drives and DVD drives. The mass storage device 2928 and/or the volatile memory 2914 may be used to store the viewing records in the home unit 124 of FIG. 1. A mass storage device such as the mass storage device 2928 may also be used to store the VOD server metering database provided as input to the example processes 2500 and/or 2600 of FIGS. 23 and 24, respectively.

As an alternative to implementing the methods and/or apparatus described herein in a system such as the device of FIG. 27, the methods and or apparatus described herein may be embedded in a structure such as a processor and/or an ASIC (application specific integrated circuit).

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method to monitor presentation of video-on-demand (VOD) content, the method comprising:
obtaining server metering data determined using a server metering device in communication with a VOD server, the VOD server to provide the VOD content specifically to a first subscriber site among a plurality of subscriber sites;
obtaining subscriber metering data corresponding to media content presented at the first subscriber site, the subscriber metering data determined using a site metering device different from the server metering device; and
electronically combining the subscriber metering data and the server metering data to monitor the VOD content provided specifically to the first subscriber site, the subscriber metering data indicating whether the VOD content was selected for presentation at the first subscriber site and including a first identifier to uniquely identify the first subscriber site, the server metering data determined independently of the subscriber metering data and including a second identifier to uniquely identify the first subscriber site and to identify a first portion of the server metering data associated with the first subscriber site, the first portion of the server metering data identifying the VOD content provided by the VOD server specifically to the first subscriber site, the first portion of the server metering data to be combined with the subscriber metering data based on the first and second identifiers.

2. A method as defined in claim 1 further comprising:
comparing the first identifier and the second identifier; and
selecting the first portion of the server metering data to combine with the subscriber metering data when the first and second identifiers are determined to correspond to the first subscriber site.

3. A method as defined in claim 1 wherein a database stores the server metering data, and further comprising receiving the first portion of the server metering data to combine with the subscriber metering data in response to querying the database based on the first identifier.

4. A method as defined in claim 1 wherein the second identifier comprises a set-top box identifier associated with the first subscriber site.

5. A method as defined in claim 1 wherein the VOD content comprises a plurality of VOD content streams, and the first portion of the server metering data includes:
session information describing a VOD session established with the first subscriber site to provide the VOD content; and
different stream information describing different VOD content streams provided to the first subscriber site during the VOD session.

6. A method as defined in claim 5 wherein the server metering data further includes a data rate and a number of errors associated with at least one of the VOD session or at least one of the different VOD content streams.

7. A method as defined in claim 1 wherein combining the subscriber metering data and the server metering data comprises replacing a generic VOD indicator in the subscriber metering data with VOD content identification information included in the first portion of the server metering data, the generic VOD indicator to indicate that unidentified VOD content was presented at the subscriber site.

8. A tangible article of manufacture storing machine readable instructions that, when executed, cause a machine to at least:
obtain server metering data determined using a server metering device in communication with a video-on-demand (VOD) server, the VOD server to provide VOD content specifically to a first subscriber site among a plurality of subscriber sites, the VOD content comprising a plurality of VOD content streams, the server metering data including session information describing a VOD session established with the first subscriber site to provide the VOD content and different stream information describing different VOD content streams provided to the first subscriber site during the VOD session;
obtain subscriber metering data corresponding to media content presented at the first subscriber site, the subscriber metering data determined using a site metering device different from the server metering device; and
combine the subscriber metering data and the server metering data to monitor the VOD content provided specifically to the first subscriber site, the subscriber metering data indicating whether VOD content was selected for presentation at the first subscriber site and including a first identifier to uniquely identify the first subscriber site, the server metering data determined independently of the subscriber metering data and including a second identifier to identify the first subscriber site and to identify a first portion of the server metering data associated with the first subscriber site, the first portion of the server metering data to be combined with the subscriber metering data based on the first identifier.

9. A tangible article of manufacture as defined in claim 8 wherein the machine readable instructions, when executed, further cause the machine to:
compare the first identifier and the second identifier; and
select the first portion of the server metering data to combine with the subscriber metering data when the first and second identifiers are determined to correspond to the first subscriber site.

10. A tangible article of manufacture as defined in claim 8 wherein a database is to store the server metering data, and the machine readable instructions, when executed, further cause the machine to receive the first portion of the server metering data to combine with the subscriber metering data in response to a query of the database based on the first identifier.

11. A tangible article of manufacture as defined in claim 8 wherein the second identifier comprises a set-top box identifier associated with the first subscriber site.

12. A tangible article of manufacture as defined in claim 8 wherein the server metering data further includes a data rate and a number of errors associated with at least one of the VOD session or at least one of the different VOD content streams.

13. A tangible article of manufacture as defined in claim 8 wherein the machine readable instructions, when executed, further cause the machine to replace a generic VOD indicator in the subscriber metering data with VOD content identification information included in the first portion of the server metering data to combine the subscriber metering data and the server metering data, the generic VOD indicator to indicate that unidentified VOD content was presented at the subscriber site.

14. A tangible article of manufacture as defined in claim 8 wherein the machine readable instructions, when executed, further cause the machine to verify the subscriber metering data using the first portion of the server metering data.

15. A system to monitor presentation of video-on-demand (VOD) content, the system comprising:
a server metering device in communication with a VOD server to determine server metering data corresponding to the VOD server, the VOD server to provide the VOD content specifically to a first subscriber site among a plurality of subscriber sites;
a site metering device to determine subscriber metering data corresponding to media content presented at the first subscriber site, the server metering device different from the site metering device; and
a facility to replace a portion of the subscriber metering data with a portion of the server metering data to combine the subscriber metering data and the server metering data to monitor the VOD content provided specifically to the first subscriber site, the subscriber metering data including a site metering device identifier to uniquely identify the first subscriber site, the portion of the subscriber metering data determined independently of the subscriber metering data and indicating that VOD content was selected for presentation at the first subscriber site, the portion of the server metering data including a set-top box identifier to identify the first subscriber site and to indicate that the portion of the server metering data is associated with the first subscriber site, the site metering device identifier being different from the set-top box identifier, the portion of the server metering data to be selected for replacing the portion of the subscriber metering data based on the set-top box identifier and the site metering device identifier.

16. A system as defined in claim 15 wherein a database is to store the server metering data, and the facility is to receive the portion of the server metering data in response to a query of the database based on at least one of the set-top box identifier or the site metering device identifier.

17. A system as defined in claim 15 wherein the VOD content comprises a plurality of VOD content streams, and the portion of the server metering data includes:
session information describing a VOD session established with the first subscriber site to provide the VOD content; and
different stream information describing different VOD content streams provided to the first subscriber site during the VOD session.

18. A system as defined in claim 17 wherein the server metering data further includes a data rate and a number of errors associated with at least one of the VOD session or at least one of the different VOD content streams.

19. A system as defined in claim 17 wherein the facility is to replace a generic VOD indicator in the portion of the subscriber metering data with VOD content identification information included in the portion of the server metering data, the generic VOD indicator to indicate that unidentified VOD content was presented at the subscriber site.

20. A system as defined in claim 15 wherein the server metering data includes a plurality of portions associated with a respective plurality of subscriber sites, each portion of the server metering data associated with a respective subscriber site in the plurality of subscriber sites and including a respective set-top box identifier to identify the respective subscriber site.
